(19) United States
(12) Patent Application Publication
(10) Pub. No.: US 2023/0068107 A1
(43) Pub. Date: Mar. 2, 2023

(54) Monitoring and risk index measuring system based on measured ecosystem services as a function of sectoral economic performance, and corresponding method

(71) Applicant: Swiss Reinsurance Company Ltd., Zürich (CH)

(72) Inventors: Rogier DE JONG, Zürich (CH); Oliver SCHELSKE, Zürich (CH); Anna RETSA, Zürich (CH)

(73) Assignee: Swiss Reinsurance Company Ltd., Zürich (CH)

(21) Appl. No.: 18/047,197

(22) Filed: Oct. 17, 2022

Related U.S. Application Data
(63) Continuation of application No. PCT/EP2021/076082, filed on Sep. 22, 2021.

(30) Foreign Application Priority Data
Sep. 22, 2020 (CH) 1198/20

(51) Int. Cl. G06T 17/05; G06F 16/29

(52) U.S. Cl. CPC G06T 17/05; G06F 16/29; G06F 2219/10

(57) ABSTRACT

A measuring and monitoring system is proposed comprising a plurality of measuring sensors and measuring devices by means of which geographically cellularly delimited measuring parameters are acquired. The measuring parameters are aggregated to a BES index, wherein the measuring parameters are selected in relation to the desired measurement accuracy of the biodiversity and ecosystem services (BES) index. The measuring and monitoring system comprises selectable, various biodiversity and ecosystem services at least comprising measuring parameters for measuring the habitat intactness and/or pollination and/or air quality and local climate and/or water security and/or water quality and/or soil fertility and/or erosion control and/or coastal protection and/or food provision and/or timber provision. The measuring and monitoring system further permits the quantitative acquisition/measurement of risk indices based on the measured ecosystem services as a function of sectoral economic services.

### CROSS REFERENCE TO RELATED APPLICATIONS

The present application is a continuation of International Patent Application No. PCT/EP2021/076082, filed Sep. 22, 2021, which claims priority to Swiss Application No. 1198/20, filed Sep. 22, 2020, the contents of each of which are hereby incorporated by reference in their entirety.

### TECHNICAL FIELD OF THE INVENTION

The present invention relates to automated measuring and monitoring systems, which make it possible, on the basis of specific measuring parameters and measurement indices, for complex processes and conditions in nature and the various ecosystems, e.g. biodiversity or biodiversity and ecosystem services, to be detected and measured quantitatively and monitored. Quite generally, it relates to automated measuring, monitoring, alarm, triggering and signalling systems and methods for measuring or assessing complex processes and system states, in particular risk measurements in connection with the occurrence of disasters and dangers associated and correlated with these processes and system states and the correlated occurrence and cumulation of said measurable measures of risk and danger.

### TECHNICAL BACKGROUND OF THE INVENTION

Global measurement and monitoring of biodiversity and ecosystem services (BES) is an important, but technically challenging task, as human activities alter the functioning of ecosystems and the structure and composition of biological populations at all taxonomic levels. To stem biodiversity loss and maintain important ecosystem services it is necessary to be able to measure and monitor the rate, the extent and the geography of these changes. In view of the extent of the necessary measures, knowledge about global changes in biodiversity and ecosystems is still limited. Moreover, what is known about the changes in biodiversity is immensely complicated by taxonomic, geographic and temporal distortions. At present, novel systems are being developed for monitoring biodiversity in order to be able to measure, monitor and assess systematically, changes over multiple taxa in large volumes. For monitoring changes in species, communities and ecosystems, various globally consistent metrics have been proposed over the course of time. These metrics are biological, they react sensitively to changes, are ecosystem-independent and have the goal of making uniform monitoring protocols possible worldwide. These efforts have been furthered by increasing access to globally available in-situ biodiversity observations. However, as in-situ data alone are not sufficient for assessing global patterns of diversity, supplementary measured data are required in order to make effective monitoring measures possible.

Earth observations (e.g. Earth Observation (EO) measured data from satellite or aerial photographs) supplement in-situ measured data, by providing repeatable, thematically consistent and spatially continuous measurements of terrestrial ecosystems, which can characterize and measure patterns of biodiversity over large, insufficiently investigated regions. However, establishing the link between field and EO data is a technically difficult challenge. This includes the evaluation of incomplete samples (e.g. if the field measurements do not adequately reflect the extent of the environmental variations) and adjustment for differences in size and scale (e.g. if field plots are much smaller than EO pixels). Development of EO-based biodiversity monitoring systems requires technically a comprehensive approach for correlating these data.

Scaling plays a central role both in the in-situ measurement of ecological processes and in EO measuring techniques. The technical linking of spatial and temporal scales in biological communities is then a central problem in the technical area and is designated as the problem of pattern and scale. The problem of pattern and scale emphasizes that often several ecological processes determine the pattern of biodiversity, and that these processes may often act over several spatial and organismic scales. Therefore there is seldom a single measuring scale that is the most suitable for measuring and detecting how particular processes control patterns. Similar scale dependencies apply to EO measurements, and the granularity of an EO sensor often determines which patterns can be measured, and only multiple-scale EO analyses can uncover the effects of multiple processes and determine the biodiversity pattern. The application of concepts for patterns and scales to EO measurements could be a means for better linking of these regions and for providing a path for improved monitoring of biodiversity.

The technical problem of patterns and orders of magnitude in ecological measuring systems is concentrated on two different measuring scales, namely granularity and extent. In the following, unless defined otherwise for these scales, they relate to scales in the spatial sense, although the temporal granularity is also described by the frequency of observations (e.g. a diurnal cycle for the net primary productivity) and the temporal extent of the total time may describe in what time interval an ecological process can take place (e.g. phenological variation over the course of a year).

Measuring scales must moreover be selected correctly, in order to be able to measure/detect biodiversity patterns (i.e. biodiversity) or ecological processes in a particular scale or a series of scales. An important dynamic in scaling is that with a change in the scale of the measurement, the variation within this measurement is also subject to a change. For example if biodiversity/ecosystem functions suggest that the relation between species diversity and productivity should be concave and a maximum biomass accumulation applies at a medium diversity both for primary and for secondary productivity. However, this functional form is dependent on cell size and cannot be used for measuring ecological processes. Measurements of patterns at community level, such as species diversity and turnover (i.e. alpha and beta diversity), has been proven to vary directly with the scale.

The measuring scales also form the technical limitation as to which biodiversity patterns can be measured by EO, i.e. by satellite-supported Earth observation (see FIG. 2). In general, fine-grained sensors can measure patterns at the species and community level, e.g. the occurrence and incidence of species and taxonomic diversity. The measurement of characters and corresponding properties of species has proved at least partially to be a technical challenge owing to the difficulties in differentiation of individual species in the EO images and EO measurements. However, certain characteristics of plants, such as the nitrogen content of tree tops and rates of photosynthesis, can even be measured at moderate granularity. High-frequency measurements can image temporally sensitive processes, such as the phenology of vegetation, but with high-frequency continuous measurements are often at the expense of coarser granularity. Coarse-grained EO sensors can measure patterns at the ecosystem level, such as disturbance regimens or the extent of ecosystems. Until now in the prior art, satellite-supported EO has concentrated on the measurement of patterns at the ecosystem level, but the increasing number of fine-grained EO sensors in orbit could extend EO biodiversity acquisition to patterns at the species and community level.

Technically there are important similarities in scaling dynamics between field-measured data, i.e. in situ data, and EO data: granularity and extent limit both the variations between the grains. Large cells tend towards more species per plot and a smaller fluctuation between plots. Equally, large EO pixels tend to contain more organisms per grain and a smaller fluctuation between the grains, which alters the specificity of the measurement. The granularity of an EO sensor therefore restricts technically the smallest possible measuring unit. However, data can be aggregated spatially to larger scales. For example, continuous pixels, which measure the same tree, could be combined to a single crown, or clusters of forested pixels can be combined to delimit forest fragments. This makes comparisons possible between crowns or fragments instead of pixels and helps bridge the gap between spatial and biological scales. This object-based image analysis is now being used more and more frequently for monitoring biodiversity, through the development of novel segmentation algorithms, which are intended for EO measurements. Although this approach makes the processing of the measured data and the ecological interpretation of EO data easier, there are also important scaling dynamics here, which are altered with the aggregation of data over scales. A technical challenge for the problem of pattern and scale is that there is seldom only one scale at which a pattern must be investigated, because often several ecological processes determine the spatial biodiversity pattern. These patterns must often be measured at several points along biological, spatial or temporal scale spectra, in order to detect how several processes control the pattern.

In the prior art there are two fundamental methods for measuring biodiversity patterns by means of EO measurements. The first is the direct measurement of patterns at the level of species, communities or ecosystems. Examples of this paradigm are the Identification of individual organisms within a species or the acquisition of the extent of an ecosystem. Secondly, biodiversity patterns can be modelled indirectly using EO as starting parameters and environmental features for predictive measurements. Examples of this method are modelling of species diversity based on measurements of the habitat structure or modelling of the distribution of species based on land cover measurements.

It may be stated in general that there is a technical need for the development of functioning measuring and monitoring systems that make quantitative and measurable monitoring of biodiversity or biodiversity and ecosystem services possible. However, the need to develop reliable monitoring systems also resides in the importance of biodiversity and the functioning of the ecosystems themselves. Biodiversity is the basis and driving force for life on Earth. Loss of biodiversity represents a danger for quality of life and the continuance of life as we know it. Biodiversity produces or supports indispensable services (so-called ecosystem services) for humanity: It provides drinking water and clean air, fertile soils and food and protects against natural hazards. If these services had to be compensated, the costs would be far higher than the financial expenditure for the protection of biodiversity. Studies show that almost half of the habitats investigated and more than a third of the world's animal and plant species are threatened. The main reasons for this are the intensive usage of soils and bodies of water and the high loading with nitrogen. In addition there is uncontrolled overexploitation of important ecosystems, e.g. the burning of ecologically important rain forests in South America and Africa. The constant loss of biodiversity threatens the existence of indigenous species throughout the world and endangers central means of subsistence for humans and the economy and the uniqueness of landscapes. The reason for the increasingly critical state of biodiversity is the interaction of several factors, namely the increasing land requirement for settlements and infrastructures and intensive agriculture. There is also increasing pressure from invasive species, micropollutants or climate changes. Technical measurement of the state of biodiversity is a complex task. The goal of the various monitoring systems and processes in the prior art is to provide measured data that make sound, technically based assessment of the state and development of biodiversity possible, i.e. measurement of a physical measure for biodiversity. Examples of such systems, which at the same time show how technically complex and wide-ranging biodiversity monitoring is, are shown for example by Switzerland's total monitoring of biodiversity, comprising (i) Switzerland's Biodiversity Monitoring (BDM), which is based on measured data for common bird species, vascular plants (flowering plants, ferns and horsetails), aquatic insects, invertebrates, mosses and butterflies, (ii) monitoring the development of the alluvial areas covered, peatlands (raised bogs and fens), amphibian spawning areas and dry meadows and dry pasturelands according to defined protection goals by means of Switzerland's so-called biotope protection impact assessment (Wirkungskontrolle Biotopschutz, WBS), which is based on floristic and faunistic measurements plus aerial surveys and analyses, (iii) Switzerland's monitoring programme “Species and Habitats Agriculture” (“Arten and Lebensräume Landwirtschaft”, ALL-EMA), which measures the state and the variation of species diversity and natural habitats in the agricultural landscape on the basis of floristic measurements, or (iv) the monitoring programme for monitoring endangered species of animals, plants, and fungi and lichens, an output of which is the so-called “Red List”, which traces in particular the long-term development of endangered species. Comprehensive monitoring based on all 4 systems now at last allows technical measurement of biodiversity. Moreover, it is to be noted with these measuring systems that agriculture and biodiversity are typically closely linked (cf. for example BIOBIO System for measurement of biodiversity on extensively and intensively managed areas). Thus, half of all European plant and animal species live on areas under agricultural use (species diversity). Agricultural crops and farm animals are differentiated into countless species and breeds (genetic diversity). Moreover, the agricultural landscape is characterized by a juxtaposition of the most varied of habitats (habitat diversity). Measuring this biodiversity as comprehensively as possible is the task of monitoring systems for measuring biodiversity. Therefore we need measurement indicators and measuring parameters that are scientifically validated and technically informative and measurable. One of the technically most difficult tasks is selection of these measurement indicators and development of an acquisition system, with which biodiversity can be measured on non-managed and natural areas, but also on biologically and extensively managed areas.

Apart from the technical task of measuring biodiversity, the measured data that are measured in this way have a variety of applications in various technical areas, as the extent of biodiversity directly affects many developments and technical processes or monitoring. For example, patent specification CN110334876 discloses a device for regulating and controlling runoff processes in the environment based on structural runoff parameters, measurements of water quality and biological measuring parameters, which comprises the following steps: (1) determination and selection of river-ecology subdivisions and identification of the most important structural runoff parameters and water quality parameters that affect the biocoenosis, i.e. the biotic community of organisms of various species in the measured, distinguishable habitat (Biotop) or site. Biocoenosis and biotope, together, form the ecosystem; (2) construction of a quantitative relation between the runoff situation, water quality factors and biodiversity indices or unit of measurement; (3) taking into account whether the measured flow is a natural flow or a regulating and control flow, and if the regulating and control influence is relevant, measurement of the rate of change of the biodiversity index under the regulating and control influence; if the measured flow is little affected by dam regulation or is a natural river, direct execution of (4); and (4) extension of measurement of the assessment index (including runoff structure, water quality factors and biodiversity index) and criteria of river health. Based on the actual measurement of the daily runoff process, intervals of the environmental runoff process are measured under various water quality and health levels. The system provides technical support in determination of the runoff process in the river environment, the effects of regulation and control of water protection projects on the biocoenosis and protection of the river ecosystem.

Another example of the systems of the prior art is presented in CN108875002. CN108875002 discloses a system based on remote monitoring and GIS (Geographic Information System) for measuring and creating a red list for desert ecosystems. The system belongs to the technical area of monitoring and measurement of biodiversity and protection thereof. The system comprises (a) creation of a classification system for desert ecosystems with selection of the technically relevant measuring parameters; (b) classification of the vegetation measuring parameters for measurement of desert ecosystems; (c) establishing a measuring standard for the level of threat to the desert ecosystem; (d) measuring a measurement index for the level of threat to the desert ecosystem; (e) classifying and triggering the level of threat to the desert ecosystem; and (f) generating a red list for desert ecosystems. The measurements are combined with spatial measurements of the degradation of habitat areas, to create a basis for the protection and management of extensive ecosystems, and the problems that the ecosystem classification can be standardized in the existing process of classification of the red list of the ecosystem, so that the fundamental assessment units can be measured, and the change processes of the ecosystem take place with corresponding quantification indices, and batch assessment can be performed at the macro level.

Great progress has been made in recent years in understanding the effects of climate. Less understood—but just as important—are the effects of biodiversity risks on the economy and industry. This also has a direct influence on the possibilities for technical measurement of these effects. Biodiversity and ecosystem monitoring systems and services (BES) form the basis of all technical and economic activities in companies worldwide and should be a part of all systems for monitoring financial services or technical control thereof. According to studies, today, 55% of global GDP is already moderately or strongly dependent on biodiversity measurements and BES. There are also enormous effects on transactions of a financial or other nature: the Dutch National Bank estimates that 510 billion euro or 36% of all investments of Dutch financial institutions would be lost if the ecosystem services on which the Netherlands economy is based were no longer available. The effects of the decline of biodiversity monitoring and of BES have for many years been a concern in the most varied areas of technology. In recent times, however, the demand for corresponding systems and processes has increased again sharply, as generally it is better understood how biodiversity and BES not only affect assets, but also industry and the economy in general. This also has effects on risk transfer technology.

### SUMMARY OF THE INVENTION

The object of the present invention is to provide a new measuring and monitoring system and method, for measuring and monitoring complex, nature-based, and geographically distributed systems, in particular for physical measurement of biodiversity and ecosystem services and correlation thereof with technical and economic processes and activities. A further aim of the invention is to provide a new measuring and monitoring system and method not only for measuring changes in ecosystems and biodiversity, but also in quantitative measurement of resultant risks within the monitored ecosystem.

According to the present invention, these aims are achieved in particular by the features of the independent claims. In addition, further advantageous embodiments follow from the dependent claims, the description and the figures.

According to the present invention, the aforementioned objects for measuring and monitoring systems for measuring and monitoring ecosystem and biodiversity services and associated risks and the corresponding methods are achieved in that the measuring and monitoring system comprises a plurality of measuring sensors and measuring devices, by means of which geographically cellularly delimited measuring parameters are captured, wherein the measuring sensors and measuring devices comprise in-situ measuring devices and/or EO (Earth Observation) measuring devices for measurement/acquisition of values of atmospheric measuring parameters and/or values of maritime measuring parameters and/or values of land-based measuring parameters, in that the measuring and monitoring system comprises a central digital platform with a core engine and a persistent memory, wherein by means of an aggregation module based on predefined parameterizations of BES indicators, measuring parameters for measuring the BES indicators are acquired by measuring sensors and measuring devices and are stored in the persistent memory, wherein the measuring parameter can be aggregated by parameterization of the BES indicators to quantitative values of the BES index for each of the BES indicators and/or a total value of BES index, so that the system comprises a correlation module comprising a plurality of parameterized stored production processes and production outputs with assigned correlation measuring indices, wherein the respective correlation measuring index measures the dependency of a production process or production output on the individual BES indices in respective, defined subsectors using the average values for each BES indicator, and in that probability of occurrence values for the occurrence of damage events or reduction of production outputs based on the measured BES index values, weighted with respect to the production processes and production outputs by means of the assigned correlation measuring indices, are measured using the average value of the correlation measuring indices for the individual parameterized BES indicators and the aggregated dependence of all BES indicators contained in the cumulative BES index.

### BRIEF DESCRIPTION OF THE DRAWINGS

In the following, the present invention is explained in more detail on the basis of examples and referring to these drawings:

FIG. 1 shows a block diagram, which shows schematically a measuring and monitoring system 1 comprising a plurality of measuring sensors and measuring devices 11, by means of which geographically cellularly delimited measuring parameters 113 are captured. The measuring sensors and measuring devices 11 comprise in-situ measuring devices 112 and/or EO (Earth observation) measuring devices 111 for measuring the values of atmospheric measuring parameters 1131 and/or values of maritime measuring parameters 1132 and/or values of land-based measuring parameters 1133.

FIG. 2 shows a diagram which shows schematically a timeline of the most important Earth Observation (EO) satellites, comprising satellites with optical/multispectral sensors, satellites with thermal sensors, in particular infrared sensors, and satellites with radar and passive microwave-sensing sensors and measuring devices.

FIG. 3 shows a diagram that illustrates schematically identification of relevant ecosystem services, e.g. with respect to their relevance for automated risk transfer technology and/or data availability. It comprises for example (i) habitat intactness, (ii) pollination, (iii) air quality and local climate, (iv) water security, (v) water quality, (vi) soil fertility, (vii) erosion control, (viii) coastal protection, (ix) food provision, and (x) timber provision. The BES index allows measurement and detection of the state of the ecosystem and its capacity by means of a reliable technical measured variable. This measured variable has varied technical relevance not only in signalling, alarm and control units of technical devices and equipment.

FIG. 4 shows a diagram which shows schematically a map with the global measured BES index with a resolution of 1 km².

FIG. 5 shows a diagram which shows schematically the correlation and interaction of biodiversity and ecosystem services with industry, society and the economy.

FIG. 6 shows a diagram which illustrates schematically the global trends in Nature's ability to make contributions by services, from 1970 to today, which show a decline for 14 of the 18 categories analysed of the contributions of Nature for humans. The measured data for determining the global trends and regional variations originate from various regional measurements and measuring stations. The measurement indicators were selected on the basis of prior use in assessments and classification in 18 categories. For the various categories of Nature's contributions, two indicators were adopted, which measure various aspects of Nature's ability to contribute to human wellbeing within this category. The indicators are defined in such a way that an increase in the indicator is associated with an improvement in Nature's contributions.

FIG. 7 shows a diagram which illustrates schematically how the sustainable development goals (SDGs) for the biosphere are the basis for all other SDGs.

FIG. 8 shows a diagram which shows schematically a classification of the threats to biodiversity and ecosystem services.

FIG. 9 shows a diagram which shows schematically indirect and direct causes and examples of declines of ecosystem services.

FIG. 10 shows a diagram which shows, based on measured data, estimated values of selected biodiversity and ecosystem services.

FIGS. 11a/b show, in the form of a table, the key areas of biodiversity and ecosystem services or the decline of biodiversity and ecosystem services and their importance for insurance and reinsurance technology.

FIG. 12 shows a diagram which illustrates the interplay between ecology and economy and the corresponding transmission mechanism to financial services.

FIG. 13 shows a diagram which illustrates the ecosystem services contained in the BES index.

FIG. 14 shows a diagram which shows the global BES index, which maps the range from very large ecosystem services to very small ecosystem services and superimposes locations.

FIG. 15 shows a diagram of an embodiment variant comprising an automated online information and mapping system, by means of which in particular the results are made available e.g. as maps for natural hazards. A tool such as HMI (human machine interface) for the BES index makes it possible for example to enlarge individual regions in a zoom function and to prepare tailor-made maps. Users can import their own coordinates and data into the tool, in order to generate tailor-made data sets.

FIG. 16 shows a diagram that illustrates the BES index classes at the country level, shown as a share of each class for a selection of countries.

FIG. 17-19 show diagrams, with a table in each case, which show the comparative share of “fragile” (very low BES class) and “intact” (very high BES class) ecosystem services as area of the respective class relative to the area of the country that is captured by the BES maps. For the dependency values, the GDP-weighted dependency scales are incorporated using min-max scaling, to make comparability possible. FIG. 15 shows a ranking of countries based on the share of very small ecosystem services (n.a. no sectoral GDP breakdown available); FIG. 16 a ranking of countries based on the share of very high ecosystem services (n.a. no sectoral GDP breakdown available), and FIG. 17 shows a ranking of countries based on the GDP dependency on the biodiversity and ecosystem services (BES).

FIG. 20 shows a diagram that illustrates the state of the ten ecosystem services contained in the example BES index, aggregated over a selection of countries.

FIG. 21 shows a diagram that illustrates as an example the correlation or the dependency of the technology and economic sectors (NACE Rev. 2) of the ecosystem services contained in the BES index. Reference numeral 1 denotes agriculture, forestry and fishery, reference numeral 2 denotes mining and quarrying, reference numeral 3 denotes manufacture, reference numeral 4 denotes electricity, gas, steam and air conditioning, supply, in particular water supply, sewerage, activities in the area of waste management and decontamination, reference numeral 5 denotes construction, reference numeral 6 denotes wholesale and retail trade; repair of motor vehicles and motorcycles, reference numeral 7 denotes transport and storage, reference numeral 8 denotes activities in the hospitality sector, reference numeral 9 denotes information and communication, reference numeral 10 denotes finance and insurance activities, reference numeral 11 denotes real estate, professional and management activities, reference numeral 12 denotes public administration and defence; social security, reference numeral 13 denotes education, reference numeral 14 denotes activities in the area of human health and social work, reference numeral 15 denotes facilities for art, entertainment and recreation; activities in the household; other activities.

FIG. 22 shows a diagram illustrating an example dependent on the BES, potentially endangered output, and the derivation of the sector prioritization from the technological and economic viewpoint (USD trn×BES dependency factor, wherein trn=value-added output, trillions USD, in constant local currency units (LCU), according to Oxford Economics Sources converted to USD prices). Reference numeral 1 denotes once again agriculture, forestry and fishery, reference numeral 2 denotes mining and quarrying, reference numeral 3 denotes manufacture, reference numeral 4 denotes electricity, gas, steam and air conditioning, supply, in particular water supply, sewerage, activities in the area of waste management and decontamination, reference numeral 5 denotes construction, reference numeral 6 denotes wholesale and retail trade; repair of motor vehicles and motorcycles, reference numeral 7 denotes transport and storage, reference numeral 8 denotes activities in the hospitality sector, reference numeral 9 denotes information and communication, reference numeral 10 denotes finance and insurance activities, reference numeral 11 denotes real estate, professional and management activities, reference numeral 12 denotes public administration and defence; social security, reference numeral 13 denotes education, reference numeral 14 denotes activities in the area of human health and social work, reference numeral 15 denotes facilities for art, entertainment and recreation; activities in the household; other activities.

FIG. 23 shows a diagram that shows examples of country profiles for a selection of countries, which show the share of very high and very low ecosystem services and the correlations of the technology sector and the economy of the country with the BES (sector-specific dependency weighted with each sector's share in the country's GDP). The matrix and measured data behind FIG. 21 visualize the fundamental relations between human-economic footprints and the environment, as were predicted in various studies, although data are still unavailable, which measure, in global comparison, the effects of each driver as classified by the IUCN (International Union for Conservation of Nature and Natural Resources) or the IPBES on each km² of the Earth.

FIGS. 24a/b shows a diagram with a table of the Aichi biodiversity targets of the UN (United Nations) up to the year 2020. The United Nations (UN) recognized the importance of biodiversity and declared, by 2020, five strategic goals and twenty targets (these are called Aichi biodiversity targets), in order to stop the loss of biodiversity. Although many of these goals and targets were not achieved, the international community has begun to negotiate a new biodiversity framework.

FIG. 25 shows a diagram that shows examples of strategic CBD (Convention on Biological Diversity) biodiversity goals relevant to the UN SDGs in conjunction with the ten components of the BES index.

FIGS. 26a-e show a listing of examples showing that the BES index comprises a broad spectrum of measurement contributions to ecosystem services. FIGS. 24a-e describe a selected group of ecosystem services, which may be contained in the BES index, together with the selected technical indicators for quantification at the global level and other assumptions taken into consideration.

FIG. 27 shows a diagram illustrating examples of preparation of the BES Index measured values 302/3021 . . . 3031.

FIG. 28 shows a diagram showing examples of transmission mechanisms. Alongside the operation of the monetary services, they are fundamental for the inventive structure.

### DETAILED DESCRIPTION OF PREFERRED EMBODIMENTS

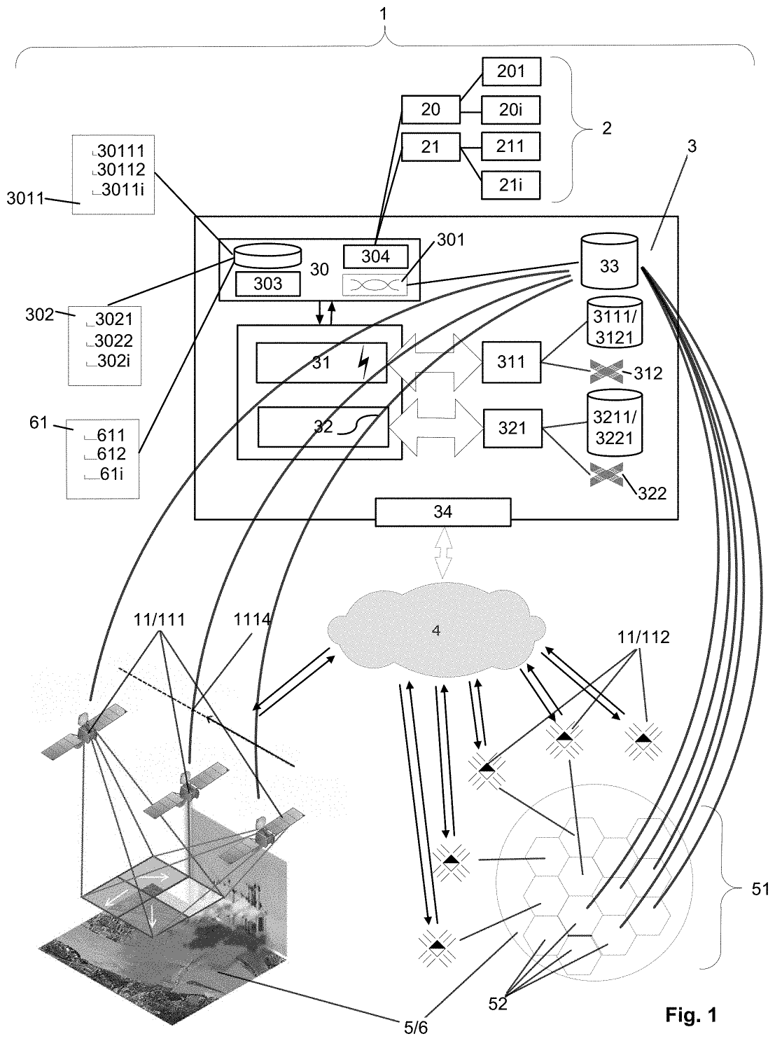

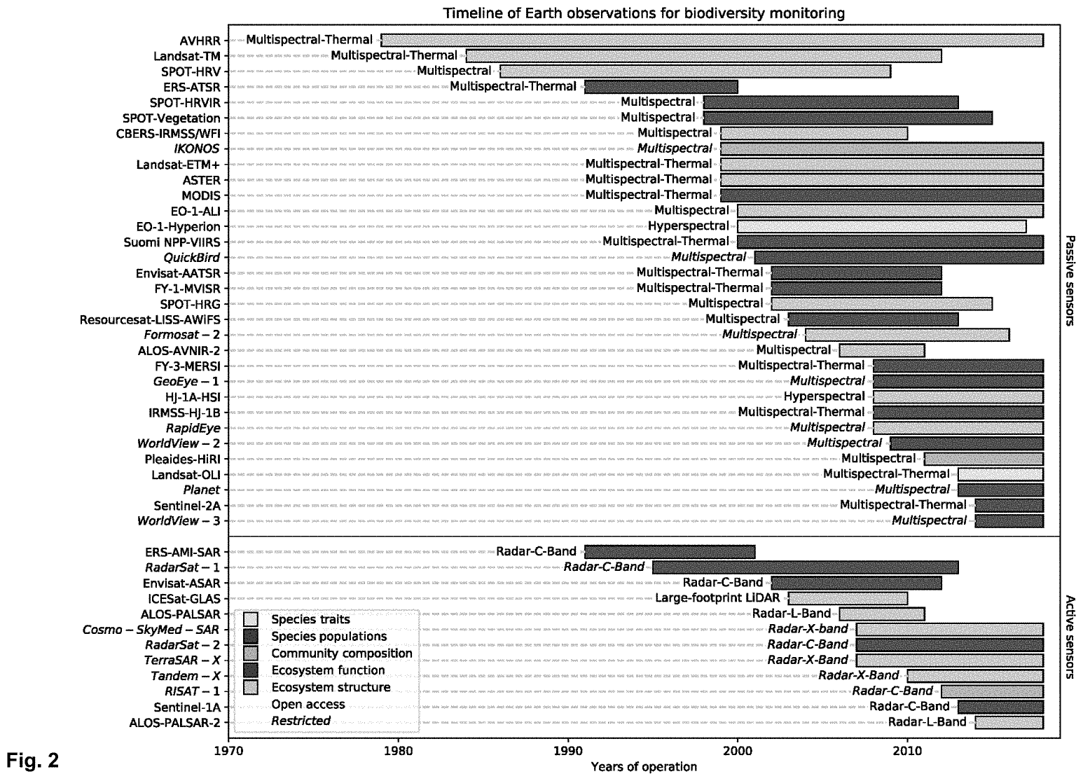

FIG. 1 illustrates schematically an architecture of a possible implementation of an embodiment variant for a measuring and monitoring system 1 of ecosystems and biodiversity according to the invention. The system 1 comprises a plurality of measuring sensors and measuring devices 11, by means of which geographically cellularly delimited measuring parameters 113 are acquired. The measuring sensors and measuring devices 11 comprise in-situ measuring devices 112 and/or EO (Earth Observation) measuring devices 111 for measuring values of atmospheric measuring parameters 1131 and/or values of maritime measuring parameters 1132 and/or values of land-based measuring parameters 1133.

The measuring and monitoring system 1 comprises a central digital platform 3 with a core engine 30 and at least one persistent memory or storage unit 33. By means of an aggregation module 301, based on predefined parameterizations of BES indicators 3011, measuring parameters for measurement of the BES indicators 3011 are acquired by the measuring sensors and measuring devices 11 and stored in the persistent memory 33. By parameterization of the BES indicators 3011, the measuring parameters are aggregated to quantitative values of the BES index 302/3021/3022, for each of the BES indicators 3011 and/or a total value of BES index 303. The BES indicators 3011 may comprise e.g. at least measuring parameters for measuring the habitat intactness 30111 and/or pollination 30112 and/or air quality 30113 and local climate 30114 and/or water security 30115 and/or water quality 30116 and/or soil fertility 30117 and/or erosion control 30118 and/or coastal protection 30119 and/or food provision 30120 and/or timber provision 30121. For measurement of air quality, indicator substances may be measured, e.g. by means of the in-situ measuring devices 112, as quantitative indicators for the air quality 30113, wherein the indicator substances comprise at least the measured nitrogen dioxide content and/or fine dust and the soot content and/or grit content contained therein and/or the proportion of non-transparent/opaque particles and/or dust ingredients comprising pollen and/or sea salts. For quantitative measurement of water quality 30116, at least one value of electrical conductivity and/or dissolved substances comprising hormones and/or fungicides and/or pesticides may be measured, e.g. by means of the in-situ measuring devices 112. As an embodiment variant, for example for measurement, the BES indicators 3011 may be selected in such a way and/or selection thereof is varied in such a way, until a defined measurement accuracy of one or more BES index values 302/3021/3022 is reached.

The measuring and monitoring system 1 comprises a correlation module 304 with a plurality of parameterized stored production processes and production outputs 2 and with assigned correlation measuring indices 21. The respective correlation measuring indices 21/211 . . . 221 measure the dependency of a production process or production output 2 on the individual BES indices 302 in respective, defined subsectors using the average values for each BES indicator 3011. As an embodiment variant, for example the BES indicators 3011 comprised with the BES indices 302 may be linked on the basis of their measurement relevance with ENCORE data (Exploring Natural Capital Opportunities, Risks and Exposure) and may be modified to their maximum measurability and weighted with respect to their correlation. The subsectors may be based for example on the Global Industry Classification Standard (GICS) of ENCORE. As a variant, the subsectors may comprise two or more hierarchic levels based on NACE Rev2 (Statistical Classification of Economic Activities in the European Community) industry classification. For the dependencies, for example based on the various classifications, discrete dependency values may be classified with the values “slight”, “moderate” and “high” and/or discretized using the stated terciles, wherein a dependency on sectors that lie in the upper tercile is assigned as “high” and in the lower tercile as “low”. Other, finer subdivisions are for example also possible. The weighted dependency may thus, for example, be classified based on the tertial into low, medium and high.

For example the correlation measurement index 21/211 . . . 221 of each production process or production output 20 may be measured by means of the correlation module 304. Moreover, for example by means of a cumulative BES index 303, all correlated BES indicators 3011 can be acquired or generated as a weighted average at least comprising the following three criteria: (i) the measured, average correlation measurement index 21/211 . . . 221, (ii) the measured maximum correlation measurement index 21/211 . . . 221, and the measured number of correlated BES indicators 3011, on which the respective production process or production output 20 depends. The performances, to be correlated and acquired or measured, of the production processes or production outputs 20 and the measured BES index values 302/3021 . . . 3031 for the BES indicators 3011 are acquired quantitatively, i.e. they are quantitative (measured) quantities. They are present in the inventive measuring and monitoring system 1 as independent observation pairs. In one embodiment variant, it may be assumed that the two quantities are distributed normally and the relationship investigated is linear. The correlation measuring indices 21/211 . . . 221 may then be generated/measured as correlation coefficients as a dimensionless measure for the strength of the relationship between the two quantitatively measured quantities of the production processes or production outputs 20 and the BES index values 302/3021 . . . 3031, i.e. as quantitative measurement correlation coefficients. Selecting of the production processes or production outputs 20 correlated with the BES indicators 3011 may, as an embodiment variant, take place by means of a machine-learning module during data analysis or data mining. Therefore a corresponding set can be extracted, e.g. from production processes or production outputs 20 or the BES indicators 3011, e.g. by means of supervised learning structures or unsupervised learning structures. This allows, inter alia, optimized data processing of the acquired measured data. As an embodiment variant, for example the correlation measuring indices 215/221 for water security and timber provision may be assigned a double weighting for generation of the cumulative BES index 303.

Based on the measured BES index values 302/3021 . . . 3031, for example by means of the measuring and monitoring system 1, probability of occurrence values or risk indices for the occurrence of damage events or reduction of production outputs 2 may be generated or measured, wherein the BES index values 302/3021 . . . 3031 are weighted with respect to the production processes and production outputs 2 by means of the assigned correlation measuring indices 21 using the average value of the correlation measuring indices 21 for the individual parameterized BES indicators 3011 and the aggregated dependency on all BES indicators 3011 contained in the cumulative BES index 303.

For generating the dependency, in a further embodiment variant, further measuring parameters may be selected for measuring economic indicators. The economic indicators may for example be selected at least partially from the sectoral economic indicators of Oxford Economics for various countries, wherein the “value-added output in % of GDP” is selected, which measures the contribution of each economic sector to the GDP and wherein for each economic sector and each country a weighted total of the dependency of the economic sectors on the BES index is generated and the weightings capture the measured share of each sector in the country's GDP.

As the system according to the invention shows, the technical measurement of risks starting from the measure of biodiversity and/or ecosystem services (BES) 61/611 . . . 621 is complex and technically demanding, as there is a massive underlying collection of risks, apart from the fact that the technical measurement of biodiversity (or of ecosystem services) as such already comprises a great technical challenge (see above). In order to make the measurement of risks technically possible, make them more efficient and in particular improve their measurement accuracy, starting from the prior art it is a technical challenge to provide a reliable, technically measurable measured variable or measurement index for biodiversity and ecosystem services (BES). The measurement index should also make it possible to measure what percentage of a country's ecosystems contribute what various levels (very low to very high) of ‘nature contributions to people’. The measurement index should also facilitate, or make possible for the first time, automated processes for incorporating risk-relevant BES factors in expert systems, measuring parameter-based triggering systems and signalling systems and generate BES-related benchmark measured quantities. Through the use of these global BES-relevant measured data, in addition industry and other interest groups are provided with new technical means for management of the processing process, operating, transfer and reputation risks associated with the decline of the BES. At the same time, the values of the measurement index parameters may also be used for development, control and signalling of technical processes, strategies and products and/or for protection of technical equipment, industries, enterprises, society and environment.

The destruction of the Aral Sea may serve as an example of the importance of technical measuring systems for precise monitoring and measurement of biodiversity/ecosystem measurement parameters and correlated risks for signalling and triggering corresponding warning systems or other automated systems. The virtual destruction of the Aral Sea shows the deep effects that an uncontrolled breakdown of an ecosystem can have on humans, industry and industrial processes and national economies. During the Soviet era, the Aral Sea was a thriving economy: thousands of people lived in the region and lived off the surrounding natural resources. The fishing industry supplied the country with almost two out of ten fishes, whereas water that fed the sea promoted agriculture. When this water was diverted for irrigating fields in other regions, the flows into the sea declined and it began to disappear. Today this sea has all but disappeared, despite restoration efforts. A high proportion of the sea sediments contain high concentrations of pesticides, which have accumulated over decades from the runoff from the land. The effects of this human-caused catastrophe are serious: the local economy and agriculture—and with them the species diversity in and around the sea and the islands—have collapsed. As a consequence, the vast majority of the population moved away, because the basis of their industry, economy and their livelihood had disappeared. The Aral Sea shows what happens when important ecosystem services collapse uncontrollably.

However, which ecosystem services are the most relevant for industry, in particular risk transfer technology and the insurance industry, e.g. for technical risk measurement, underwriting and establishment of the necessary risk capacity? FIG. 1 shows the ecosystem services which in connection with the present invention have been identified as the most relevant for industry, control of technical equipment, in particular control by means of machine-learning control units, signalling devices, alerting and forecasting systems and/or automated risk transfer units etc.

(a) Relevance of the BSE Index Value for Event-Triggered, Automated Systems, in Particular Risk-Based Systems

The risk transfer industry is dependent on functioning national economies, in which economic participants and other economically active units can produce technical property values (industrial plant etc.) and assets by activities that are worth protecting. If the operation of technical property values and assets of this kind is disturbed through the breakdown of ecosystems such as in the case of the Aral Sea or are interrupted and lost or must be given up, on the one hand this represents losses of long-term and not indirectly otherwise usable investment funds, on the other hand such a collapse may also have effects on other economically relevant branches of industry or regions. An analysis by the Dutch National Bank (De Nederlandsche Bank, DNB) in conjunction with the IPBES (Intergovernmental Science-Policy Platform on Biodiversity and Ecosystem Services) indicates that this is not only possible, but also probable. Other more recent biodiversity-related studies of economic actors or political decision-makers underpin this further.

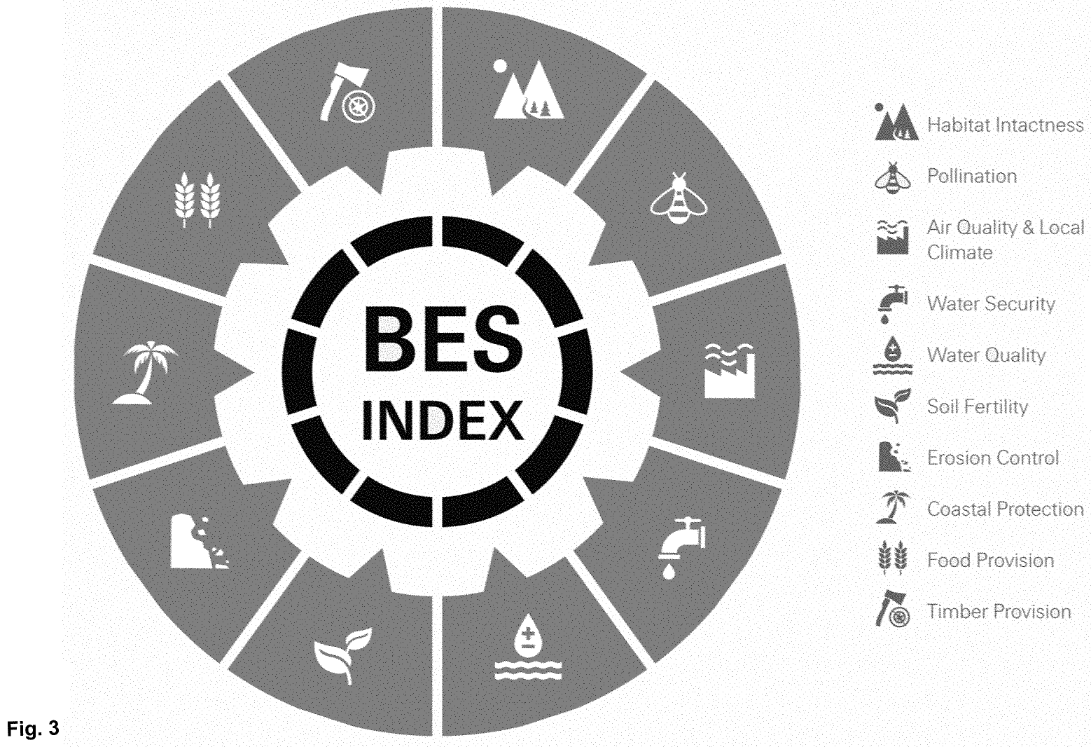

As shown in FIG. 3, there are various ecosystem services 61: water, soil and biodiversity are in this category. Others are sources of nature-based materials such as timber, fibres or pharmaceuticals, pollination, erosion protection and clean air. The last two are good examples of services that are particularly relevant to technology, industry and business. If for example we consider erosion protection on the property side of an enterprise, coastal and riparian forests and mangroves offer important erosion protection. Roots form a natural bulwark against waves, and when there is heavy rainfall may to a certain extent also store water. In areas where forests have disappeared, landslides occur more frequently, and storm surges may come farther inland and cause damage to equipment and people. Respiratory tract diseases represent a further example in the area of risks to life and health and constitute one of the main causes of lung damage worldwide, with costs increasing further. Respiratory tract diseases have a strong spatial link to the absence of woodlands or parks of a sufficient size. Forests can clean the air naturally, and where they are present, there is a lower incidence of respiratory tract diseases than in areas without trees. These are just two examples of how for example the area of risk transfer technology may be affected. Yet others could be listed: business interruption in shipping and power cuts in drought conditions, adverse consequences for agriculture, water shortage and soil fertility. Although these examples are typically presented as risks, i.e. as probabilities of occurrence or frequencies of occurrence for enterprises, they may also be converted into odds for insurers, reinsurers and investors. Replacement investment in ecosystems may strengthen their services and reduce these risks. Since all economic sectors, including the technology sectors, are dependent on BES in some way, directly or indirectly, the question arises: How can a measure for BES be measured technically, e.g. a decline of BES.

In order to understand whether the ecosystem services (BES) 61 are measurably in decline, it is necessary to determine which ecosystem services and ecosystem factors/parameters are relevant and measurable at a particular place, and then their state has to be measured. The BES indices 302/3021 . . . 3031 were developed in order to develop this kind of measurement analysis. To understand whether the BES 61 are measurably in decline, it is necessary to determine, for the ten BES 61 in FIG. 3, which ecosystem services and ecosystem factors/parameters are relevant and measurable at a particular place, and their state has to be measured. The BES indices 302/3021 . . . 3031 were developed in order to develop this kind of measurement analysis. The ten ecosystem services shown in FIG. 3 were aggregated to the overall BES index shown in FIG. 3, i.e. the cumulative BES index 303. This map offers a visualization of the state of the various ecosystem services that are covered by the BES index for each square kilometre of land.

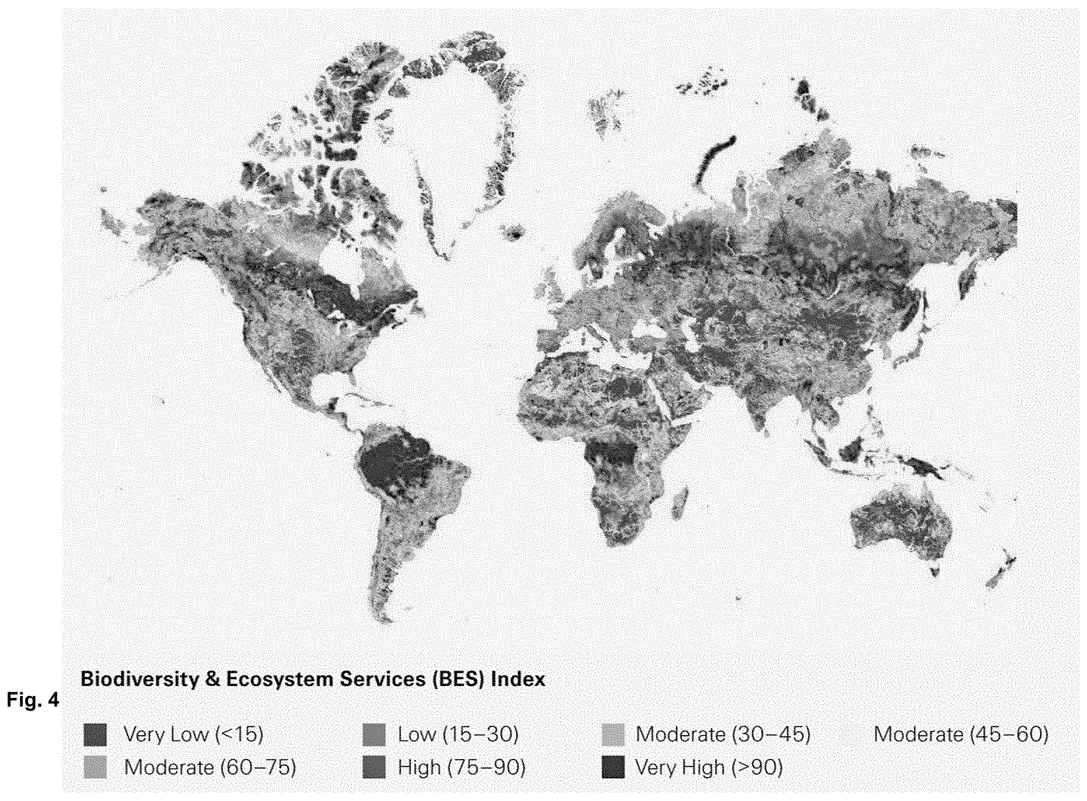

In FIG. 4, three ecosystem services were aggregated to the overall BES index shown in FIG. 4, i.e. the cumulative BES index 303. The map in FIG. 4 offers a visualization of the state of the various ecosystem services 61, which are covered by the BES indices 302/3021 . . . 3031 for each square kilometre of land. The map for the overall index (FIG. 4) shows many “red” regions (i.e. “very low” BES index value), which indicates where the BES are so susceptible that any further usage could accelerate a decline. Some of these fragile areas comprise densely populated and economically important regions, in which the economy comprises many plants, assets and activities, which for example are protected by means of risk transfer. A slow but constant degradation may lead to turning points and then to a sudden collapse of the ecosystem. As the map with the BES measured values, i.e. the BES indices 302/3021 . . . 3031, shows, the state of the BES is already “low” in several key regions compared to other regions. Starting from the technical problem of measurement of the BES, after the measurement the question arises as to how these measured values can be used technically, e.g. in (automated) risk transfer technology.

(Automated) risk transfer technology, in particular insurance and reinsurance technology, is based on three principles: (i) risk selection: select risks that are technically measurable, parameterizable and detectable; (ii) risk management: the insured are expected to take cost-effective measures for risk management; and (iii) suitable risk pricing and/or resource allocation: insurance premiums reflect the residual risk after risk management, i.e. the measured degree of threat/probability of occurrence of the event with the extent of its impact, which remains after all efforts have been made for identifying and removing risks.

For implementation and machine-based application of these principles, the automated risk transfer disclosed here follows a data-based approach. The following is an outline of how this structure can be used as a basis for automated decisions of corresponding expert systems.

Measurement of the extent to which a risk is correlated with a BES decrease requires the following measured data and information: (i) Which ecosystem services (BES) are provided at the geographic site or cell, as risk site; (ii) What is the measured status of the BES at this site or geographic cell; (iii) How are the measured probabilities of the occurrence of damage and intensities, covered by a risk transfer, correlated with the BES or the status of the ecosystem services; and (iv) What is the possible role of investors and risk transfer systems in development, in order to develop nature-based solutions for improving the ecosystem services, which contribute to risk reduction. The BES index measurement unit 302/3021 . . . 3031 of the invention helps to answer these key questions. Consider the following example: A large coastal property is located in a hurricane region. The height above sea level is only 10 m, and the main danger, i.e. the measured probability for the occurrence of a physically measurable damage event, is storm surge. The BES 61, which determine whether the plot is heavily exposed to storm surge, is protection by coral reefs or mangrove forests along the coast. If intactness is high, the risk is transferable by a low resource allocation or premium. If it is low, the resource allocation or premium must be higher or the risk of the property is possibly not automatically transferable. If coral reefs or mangrove forests are destroyed, either a man-made storm surge protection will be necessary, or risk transfer cannot technically be offered automatically at all by a (financial) risk transfer system. This example illustrates a clear link between the measurable health of a relevant ecosystem 6 and its services (BES) 61 and the necessary resource allocation for adjusting the transferred level of risk, or costs and the availability of risk transfer for an object, e.g. a technical installation, property etc., its value and insurability dependent on the respective BES 61/611 . . . 621.

Measurement of storm surges may be given as an example of the physical measurability and measurement of such events. In the case of storm surges, for example measured data may be obtained from the wave channels and natural data of local measuring sensors. The results of the data analyses used here show that the shore profile development during a storm surge in large-scale, two-dimensional simulations can be simulated technically corresponding to nature. If a corresponding scale (1:1) is maintained both in reproduction of the profile form and the sediment properties, scale effects may be ignored. Model effects on the development of the shore profile caused by the storm surge can also be minimized technically, if the measurement and simulation parameters are established correspondingly. Only after conversion of the shore profile or a change in the measurement and simulation parameters, in the breaker zone there may be unnatural sand shifts from the side walls to the middle of the channel, and technical structures must be added to take them into account. The technical structures thus developed from the data analysis, together with the approaches developed for determining the break point and the height of wave run-up over sand shores show that in the region, defined by these two positions, of the largest hydrodynamic changes, the corresponding measurements are performed with sufficient measurement accuracy. Furthermore, added basic conditions relating to the extent and the required time points of the shore profile surveys allow a reduction of expenditure in performing the analysis of the measured data. On the basis of comparison of hydrodynamic and morphological data, a technical structure may finally be provided for determining the coastal-normal sediment transport rate. This is based, like the aforementioned technical structures for the break point and the height of wave run-up, on an almost unlimited number of simulation series with similar input parameters. Other events (earthquakes, tornadoes, drought etc.) would have to be to measured and simulated correspondingly.

Many examples could be given, linking specific ecosystem services (BES) 61/611 . . . 621 with transferable risks and activities. Additional examples are discussed in the following. Through technical application of the BES index measurement unit 302/3021 . . . 3031 to relevant risks, risk transfer portfolios can be measured for their BES exposure. The BES index 302/3021 . . . 3031 of the invention may also be relevant for company and government customers who are looking for a particular risk transfer, as it can be used technically for automated verification of sites for factories, warehouses and other objects that form part of supply chains. Corresponding expert system decisions in connection with the BES can be applied not only for risk transfer underwriting, but also for measuring an enterprise's resilience in the face of a decline of the BES. The use of the BES index measuring parameter or its measured value is not included here. Insurers can also use it to measure their exposure on the plant side—for example, the measurement index can be used for automatically minimizing exposure of investments to a worsening of the BES. The measurement index 302/3021 . . . 3031 of the invention also offers new possibilities for nature-based risk transfer solutions and investment opportunities.

In regions in which the ecosystem services are in decline, establishment of a financing mechanism for protection equipment through risk transfer and monetary resource allocation provide long-term protection and represent a sustainable investment opportunity for the future. Further current examples of the economic effects and consequences of damage and degradation of ecosystems:

1. Loss of the Amazon forest has effects on (micro) climate, water supply, carbon storage and soil integrity. Deforestation affects water supply in Brazilian towns and neighbouring countries. It also affects the actual farms driving deforestation forward, and causes water scarcity and soil degradation. Further deforestation may also have effects on the global water supply.

2. The insidious destruction of corals and mangroves in Sri Lanka has led to heavy coastal erosion and increasing destruction and loss of human life on land through storms and tsunamis, e.g. the earthquake and tsunami event of 26 Dec. 2004.

3. The runoff of nutrients (nitrogen and phosphorus) into rivers through agricultural practices in the water catchment area of the Mississippi in the USA causes every year, owing to algal blooms and oxygen deficiency, a dead zone in the Gulf of Mexico, which leads to the collapse of prawn and oyster fishing (at least 300 million USD per year).

4. Invasive species cost global agriculture approximately 540 USD billion annually, or the US economy alone more than USD 100 billion per year. Eurasian watermilfoil, an example of an invasive aquatic plant species, has reduced the value of Vermont lakeside real estate by up to 16% and Wisconsin lakeside properties by 13%. Further examples are invasive mussels, which colonize and corrode water pipelines and block the flow of water, so that the operating costs for the utility companies are rising; cheatgrass, which fuels forest fires, intensifies the technical difficulty of firefighting and therefore the costs and damage to equipment and property; and the Asian citrus psyllid attacks orange groves, with corresponding damage.

5. Biodiversity is of decisive importance for pharmaceutical development, as about half of all approved modern medicinal products in the last 30 years were developed from wild species. Critical recent examples: scientists developed the malaria drug artemisinin from sweet wormwood, while the Madagascan Evergreen and the Pacific yew have provided treatments against cancer.

6. Insects are the globally most important pollinators and have declined in recent decades by 20%-40% (estimates vary depending on the source and method of meta-analysis). 75% of critical foodstuff plants depend on animal pollination, including fruit, vegetables, nuts and seeds and important cash crops such as coffee and cocoa. The global annual market value of animal-pollinated crops is estimated at 235-577 billion USD (OECD 2019).

(b) Relevance and Correlation of Ecosystem Services (BES) and Biodiversity, and Dangers for Ecosystem Services

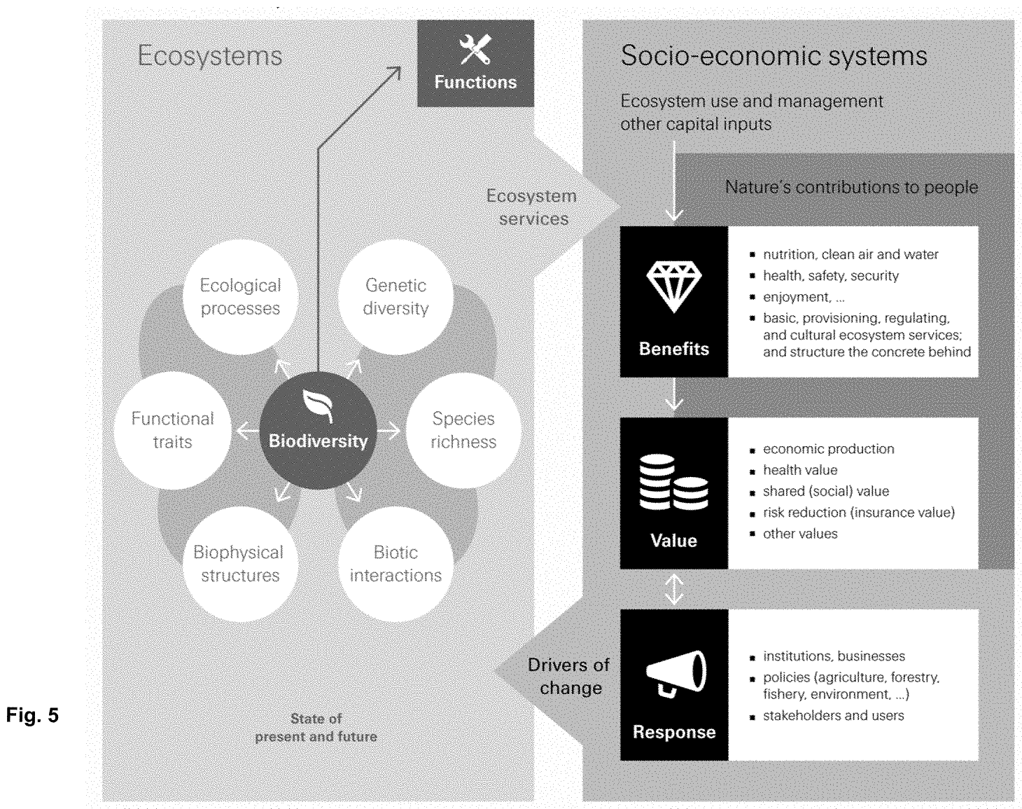

Ecosystem services (BES) 61 are essential for the functioning of industry, societies and national economies. FIG. 5 shows the interaction of biodiversity and ecosystem services with industry, society and business; it explains the BES-related transmission mechanism between financial services and real economy, on the analogy of the transmission mechanism in the interest rate system (credit & investment contracts, insurance protection). The relevant terms, as used in connection with the invention, are defined in greater detail in the following. Biodiversity as a measuring parameter measures the number, diversity and variability of living organisms (animal and plant species, fungi, microorganisms). It comprises the diversity within species, between species and between ecosystems. The term also comprises the manner in which diversity changes from one place to another and over time. The familiar 13 species inventories are—mainly owing to limited field samplings and measured data—too incomplete to provide an accurate picture of the extent and distribution of all components of biodiversity. Ecosystem services (ES) are services that are derived from and produced by ecosystems, according to the Millennium Ecosystem Assessment (MEA 2003): “Ecosystem services can be classified as temporary (e.g. fibre, food, freshwater production), regulatory (e.g. disease management, climate regulation, freshwater purification), supportive/processes (e.g. nutrient cycle, pollination, soil formation) and cultural (e.g. cultural/religious/spiritual, aesthetic, educational, recreational).

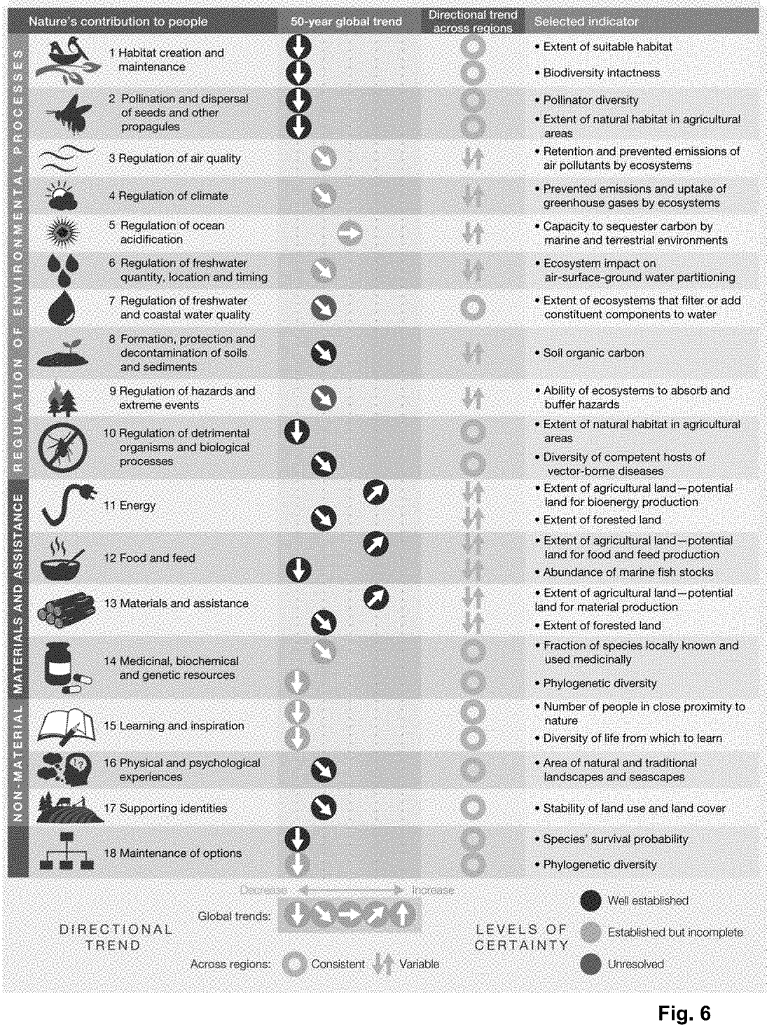

Nature's Contributions to People (NCP) are all the positive and negative contributions of living nature (i.e. the diversity of organisms, ecosystems and the associated ecological and evolutionary processes) to the quality of life of humans. The useful contributions of Nature include things such as food provision, water purification, flood protection and artistic inspiration, whereas the harmful contributions include the transmission of diseases and overexploitation, which are harmful to humans or their assets. Many NCP may be perceived as useful or harmful depending on the cultural, temporal or spatial context. For example, 18 NCP can be identified, grouped by nature of the contribution that they make to the quality of life of humans: regulating, material and non-material NCP (see FIG. 6 fora comprehensive list and global trends).

For the ecosystem services it is important which species occur and to what extent, and how many species there are. In contrast to other goods, many ecosystem services are not measured, assessed or marketed at readily observable prices. The manner in which ecosystems are used often takes the supply and renewal of ecosystems for granted. The worsening of ecosystem services could be slowed considerably or even reversed if the role of biodiversity and its full contribution to the economic and technical output formed an integrated component of the decisions of government agencies, companies and other interest groups. Loss of species can destabilize ecosystems and may, because of how species and ecosystems are interlinked, suddenly interrupt the flow of benefits from Nature to humans.

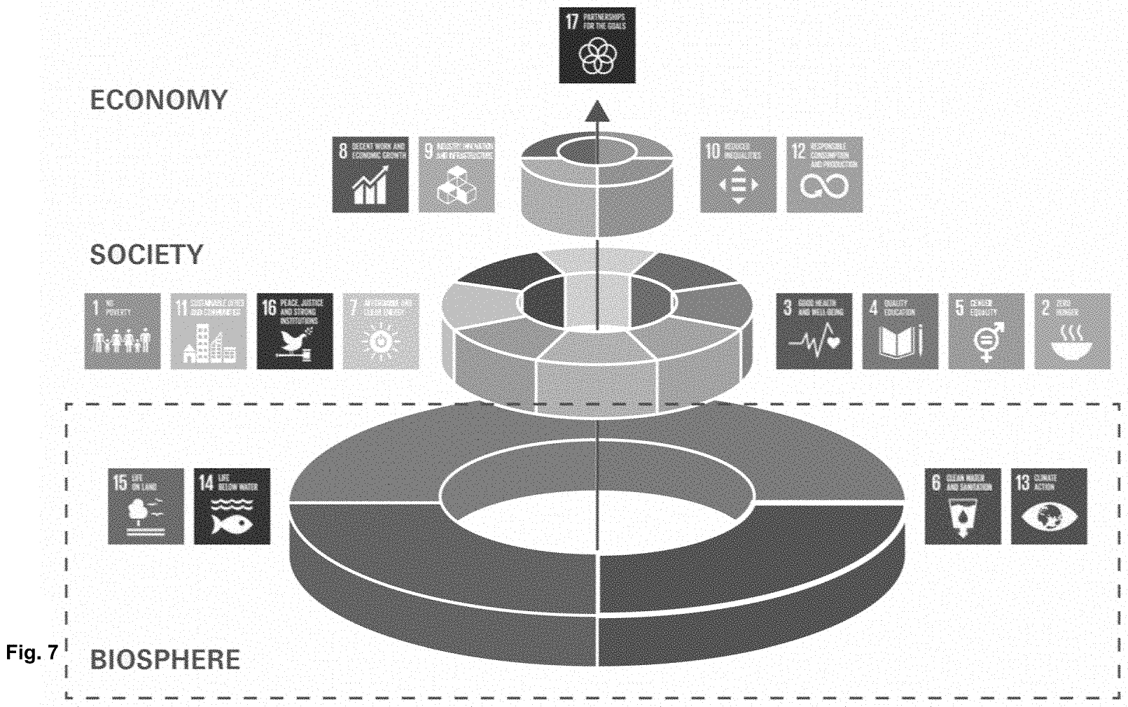

The redundancy of species is a measurable quantity for the resilience of ecosystems in a period of continuous decline, as certain species can replace the basic functions of other critically endangered species. However, this relation will not hold for ever, as there is the potential danger that ecosystem services no longer function correctly, or abrupt environmental changes occur. The present (developing) scientific consensus is that the relations between biodiversity and ecosystem functions are positively concave (with a functionality of the ecosystem services of up to 100% on the x-axis and increasing species diversity on the y-axis), wherein a decreasing marginal contribution of the next-most important species plays a role. However, the individual relations between biodiversity, ecosystem functions and ecosystem services, which affect biodiversity and the contribution to economic value, are very varied. These relations depend on compromises between different ecosystem services and between expected economic returns and risks. They also depend on various utility functions, which depend on sociodemographic classifications of individuals and their preferences, and on environmental and economic traditions and trajectories, which are different from country to country. These links show why the biosphere-related sustainable development goals for life on the land and life underwater—which represent biodiversity and ecosystems—are the basis for all other sustainable development goals (SDGs), as shown in FIG. 7.

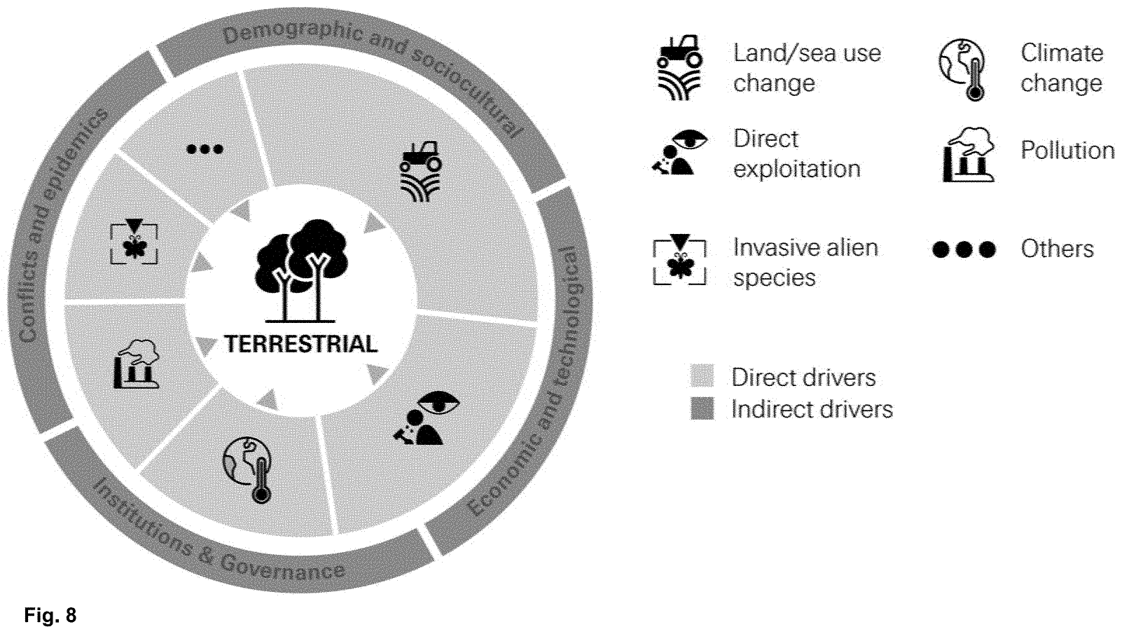

Reasons for the decline of biodiversity and the worsening of ecosystem functions are varied, i.e. the interaction of many factors leads typically to the decline of biodiversity and damage to ecosystems. The most important direct driving forces are (i) changes of habitat and land use, including the fragmentation of forests and expansion of infrastructure and other built-up areas; (ii) invasive species, which become established and spread outside of their normal geographic distribution; (iii) overexploitation of natural resources; (iv) pollution—in particular through excessive use of fertilizer, which leads to a high nutrient content of soils and water; and (v) climate change. FIG. 8 shows a detailed classification of these driving forces.

The international Union for the Conservation of Nature (IUCN) assesses the conservation status of species regularly. At present more than 31 000 or 27% of the species assessed by the IUCN are threatened with extinction. IPBES estimates that of the 8.1 million animal and plant species on Earth—with most of these species still unknown to mankind—about 1 million are threatened with extinction. In contrast to the monitoring of biodiversity, at least with regard to threatened species or species diversity, the global monitoring of ecosystem services has not so far been as comprehensive and regular. IPBES recently assessed global trends of the extent to which ecosystem services will be able to maintain Nature's contributions for humans (see FIG. 6). Most of the 18 ecosystem services investigated show a decline in contributions in the last five decades. Many of these services cannot be replaced completely by others (IPBES), and even if a substitution were possible, it is often associated with higher costs or negative external effects. For example, the use of chemical pesticides instead of natural pest control may be injurious to the health of humans, animals and plants (IPBES/DNB).

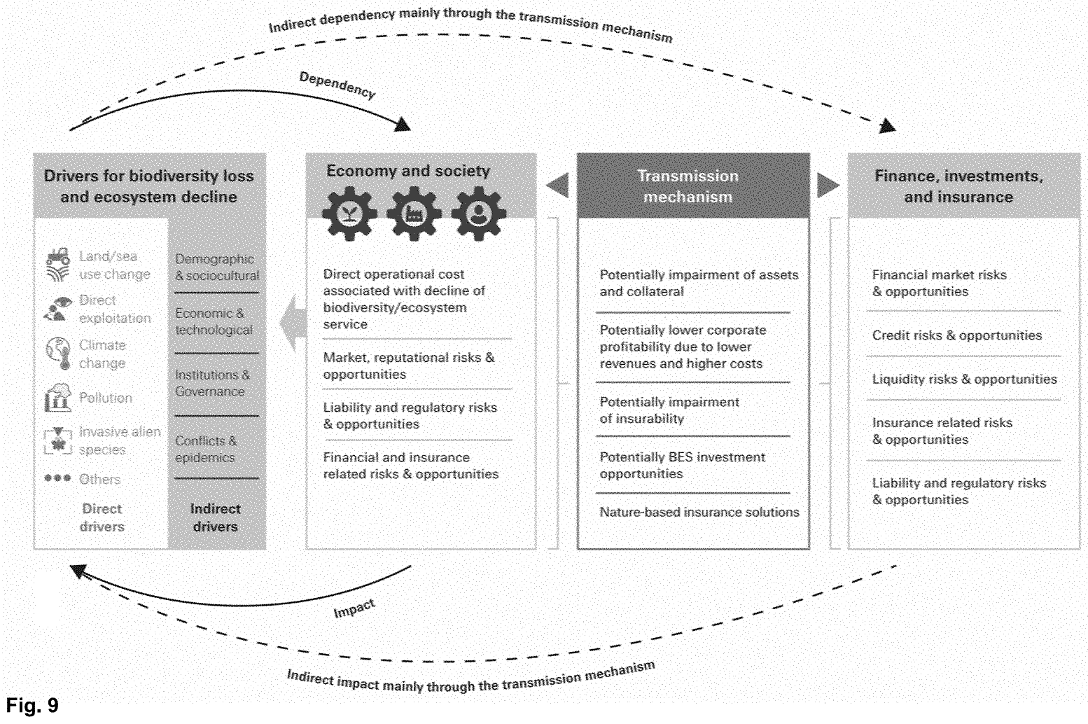

Indirect driving forces (drivers), such as the human population (especially population density), economic activity, technology and socio-political and cultural factors also affect biodiversity. The biodiversity and ecosystems in certain regions have also been impaired considerably by climate changes. With the intensification of climate change, it is expected that the harmful effects on the ecosystem services in most regions of the world will outweigh the potential advantages (such as longer growth periods) (IPCC: Intergovernmental Panel on Climate Change). In fact it can be assumed that climate change will intensify the risks of species extinction, from floods, drought, population decline and disease outbreaks. Many of the activities that have negative effects on biodiversity are becoming more and more harmful and in addition occur at the same time. Their effects will become more severe in future due to climate change (IPCC). Studies suggest that climate extremes will lead to abrupt changes in some ecosystem dimensions, long before political measures for management of the slowly developing average conditions have been implemented. At the same time, science has not yet fully understood these potential abrupt changes of ecosystems. FIG. 9 illustrates the indirect and direct drivers that are leading to worsening of ecosystem services, with some concrete examples.

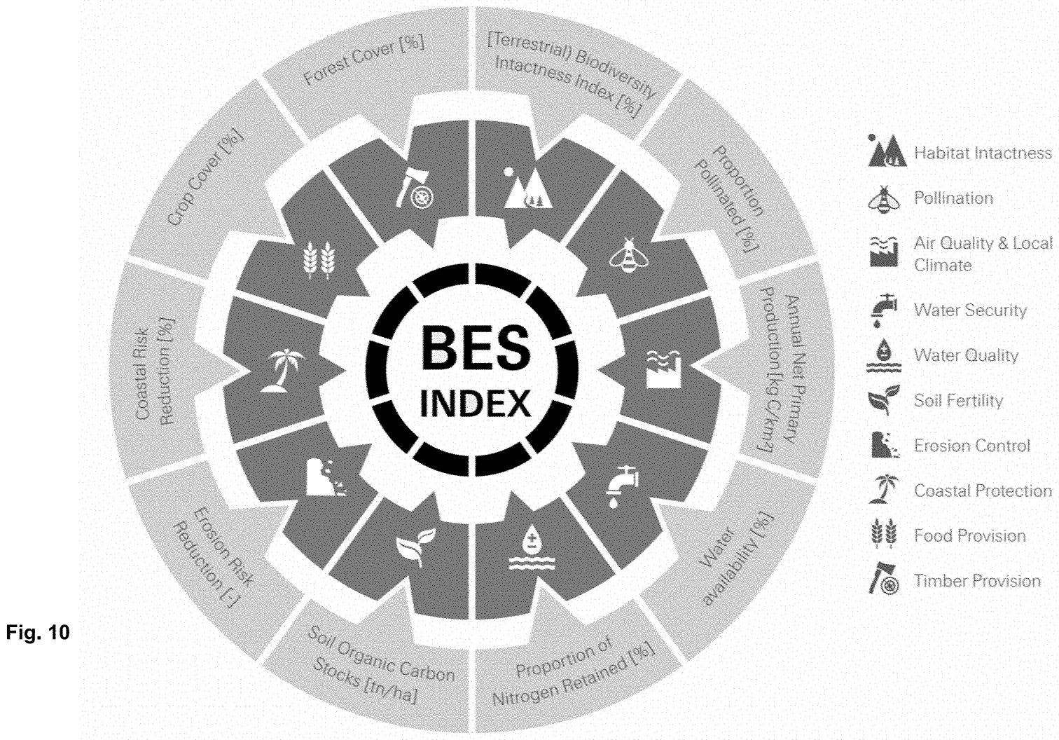

Since the end of the 1990s, economists have better measured and understood the essential contributions of Nature to functioning industries, national economies and societies. Studies estimate that the global ecosystem services produce an annual benefit in the order of 125-140 trillion US dollars. Concrete examples range from the global annual value of the nutrient cycle of seaweed at the level of 1.9 trillion USD to a global annual market value of 235-577 billion USD for animal-pollinated cash crops or an initial sale value of fishery and aquaculture of 362 billion USD annually, and other country-specific examples. FIG. 10 shows concrete examples (OECD: Organization for Economic Co-operation and Development). The loss of biodiversity and the impairment of ecosystems are endangering these values increasingly. The OECD estimates that between 1997 and 2010 the changes in global land cover have negatively impacted Nature by 4 to 20 trillion USD annually; and the losses through soil degradation came to an additional 6 to 11 trillion USD per year. These wide ranges could be interpreted as a sign that the scientific debate about the monetary effects is stalling. Investments in biodiversity and the restoration of ecosystems can reduce the risk of damage through natural disasters. For example, according to studies, the restoration of the ecosystem (diversion of rivers, creation of marshes, accompanied by the construction of dykes and other structures) along the coast of Louisiana would lower the expected flood costs by 5.3 billion USD to 18 billion USD annually. Worldwide, an annual investment of 5-10 billion USD in the protection of coastal wetlands could reduce the payments for flood damage by 52 billion USD annually. Without the fragmentation of the coastal mangroves, tsunamis would have had less significant effects. And without functioning coral reefs, according to studies the flood damage in 100-year storm events would increase by 91% to 272 billion USD. Another study quotes another example for the economics of biodiversity: The global seafood industry with an annual turnover of 252 billion USD would increase its annual revenue by 53 billion USD, if it were to invest 5-10 billion USD annually in the preservation of biodiversity, which would lead to more fish and shellfish. Industry, enterprises, communities, families and individuals suffer from these losses. In fact, changes in biodiversity and ecosystems affect operating approval for industry and enterprises (ecological/physical risks), while more extensive changes may affect policies, user preferences, reputation and even capital costs and the perceived investor's exposure (e.g. TEEB (The Economics of Ecosystems and Biodiversity), OECD, DNB).

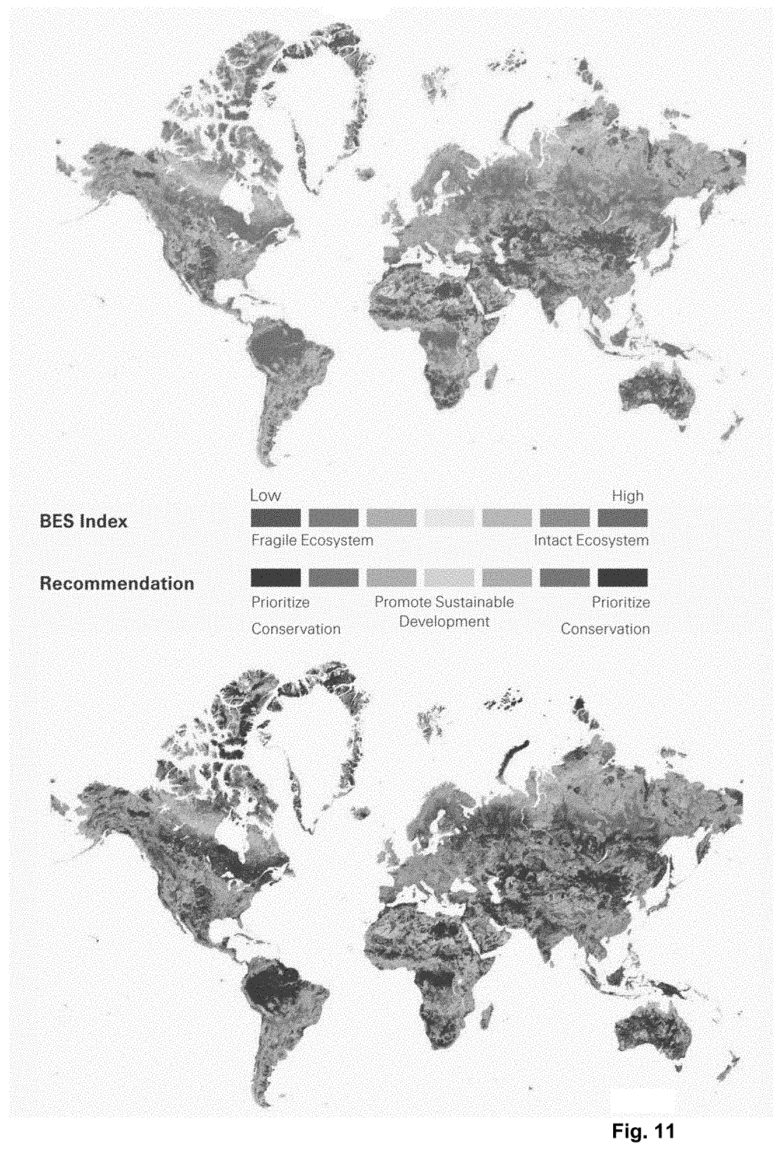

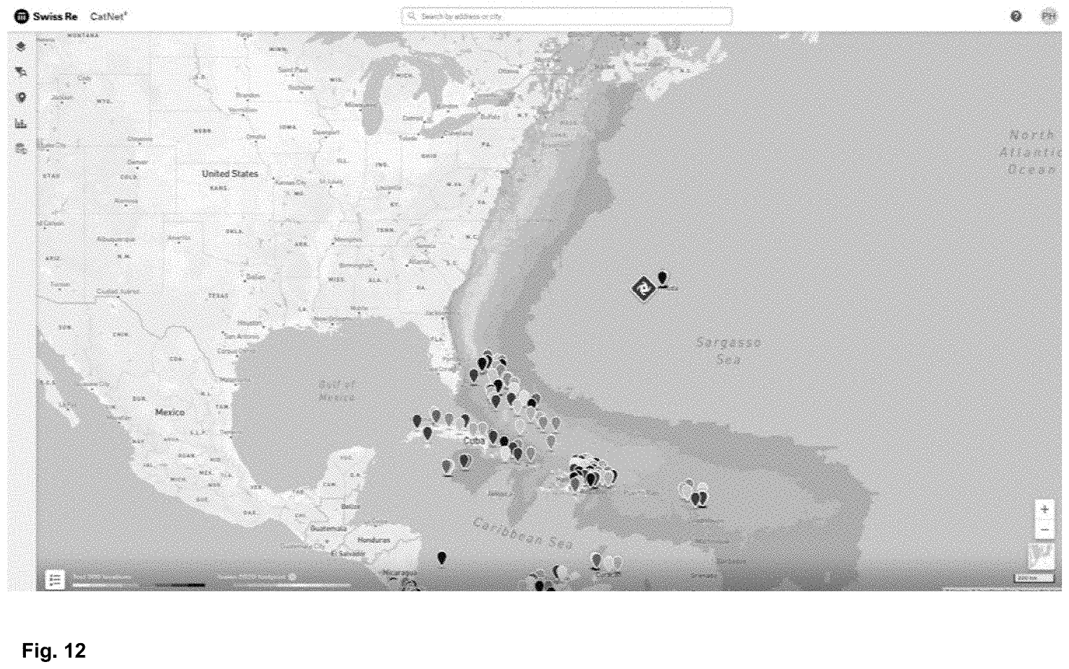

Biodiversity and ecosystem services are relevant to insurance and reinsurance technology. The key regions of importance are listed in FIGS. 11a/b. FIG. 12 gives a review of the risks of degradation of the BES, including the drivers and the automatic interaction with financial and insurance markets. This interaction is usually known as the transmission mechanism. Through this mechanism—through the provision of capital or risk protection for their customers in other sectors of a national economy—investors, lenders and insurers enable and influence the activities of these sectors to a varying extent. Although technology and science are making progress in the measurement and assessment of the question, e.g. agriculture or the processing industry through their direct productive activities depend on certain ecosystem services and influence them, the debate about how financial services indirectly affect ecosystems and the effects of other economic sectors has only just begun. The prior art comprises systems for systematic and quantitative measurement and assessment of risks that arise from loss of biodiversity and the decline of ecosystem services, for investments that are held by defined financial institutions. The dependency factors developed by the NCFA (Natural Capital Finance Alliance) can be expanded for technical use. They allow simulation of expected losses, in particular monetary losses, that may arise through loss of ecosystem services. Studies have shown that a loss of ecosystem services would lead to considerable disturbances of business processes and to financial losses. Studies also analysed indirect dependencies of ecosystem services and concluded, e.g. for Dutch financial institutions, that 510 billion euro or 36% of the 1.4 trillion euro of investments that are held by Dutch financial institutions are strongly or very strongly dependent on one or more ecosystem services. This corresponds to the total expected financial losses if the ecosystem services were equal to zero. The precise level of this risk is site-specific, as both the business activities and their value-added chains are spatially limited. In particular, in order to be able to measure the site-specific state of the ecosystem services and the correlations thereof, the BES index was devised, by superimposing measured data for ten important ecosystems on a grid-based (cell-based) resolution of 1 km², which are globally comparable. One of the aims of the BES index is to enable the automated expert systems to take measures or make decisions that are more sustainable and more ecosystem-friendly. These measures should reduce the risk of socio-economic systems reaching tipping points, and thus avoid abrupt environmental changes, which may lead to irreversible losses of ecosystems and prohibitive costs for industry and national economies. The international debate on protection of nature calls for an increase in protected areas by up to 30% of the Earth's surface (CBD: Convention on Biological Diversity). In addition, it calls for an appropriate environmental management of all socio-economic activities within these areas and finally a reduction of the severe negative effects on Nature. This expansion of the protected areas seems to be necessary in order to offer more, and less disturbed, habitats for the survival of species. The BES index may also be employed for measuring activities in protected areas. While the measurement index technically makes it possible to measure the state of the ecosystems as relevant for risk selection, risk management and risk pricing in each part of the Earth, it also provides a measurement approach that is fully global, integrated and oriented on conservation for the whole planet Earth.

(c) The Biodiversity and Ecosystem Services (BES) Measurement Index

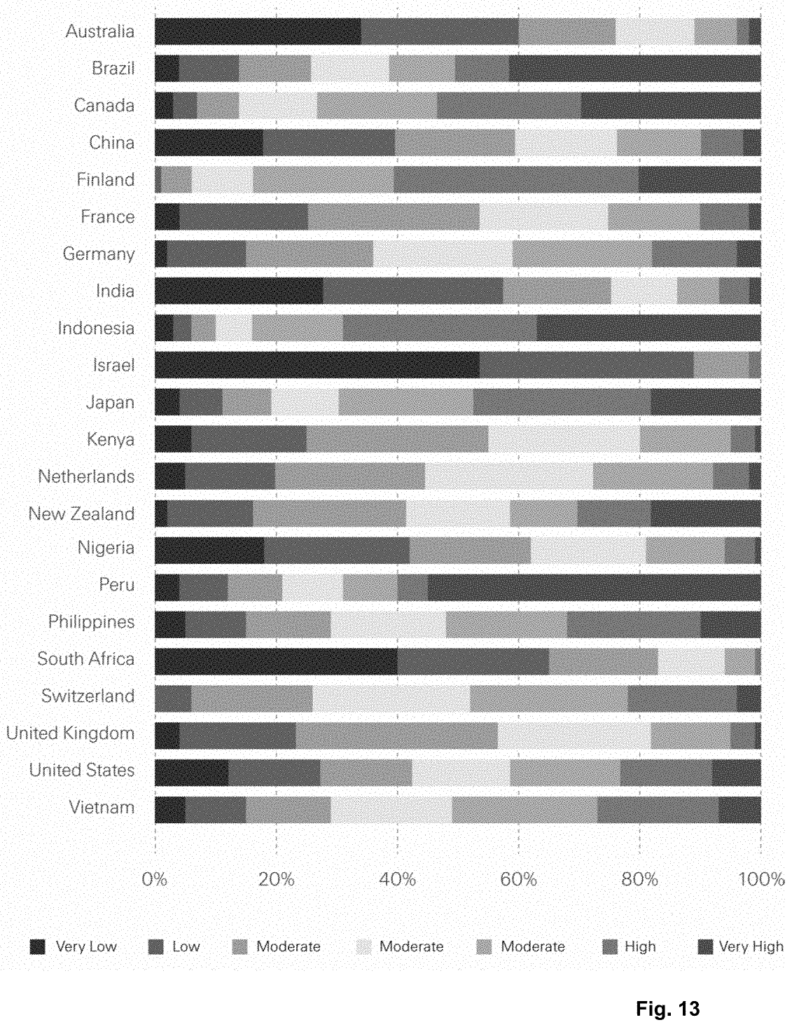

The state of the BES can be provided with the measurement index e.g. from a globally comparative assessment of a 1 km² resolution for aggregates at the country level. Based on the IPBES classification, a set of ten BES indicators and measuring parameters was selected, which concentrate on terrestrial ecosystems. The selection is based on the relevance of the BES for the insurance and reinsurance industry and the various branches and on data availability. Although the important biodiversity in aquatic and marine ecosystems and its contribution to several BES is recognized, the main focus of the BES index is the terrestrial ecosystems—these represent the majority of the risk sites, and a wide range of methods of measurement and corresponding data sources is available for their quantification. However, the BES index can easily be expanded technically to include aquatic and marine ecosystems, provided the data quality will have improved and the various requirements are met. In order to quantify the provision of ecosystem services (BES) by measurement, an indicator is selected for each service, which is derived from one or more measuring parameters and/or aerial and/or satellite measurement data, wherein these are mapped on a global scale, e.g. based on geographic cellular units. The result is a globally comparative indicator measurement system for the state of the ten BES that are the most important for the insurance and reinsurance industry (FIG. 13). Then all BES present at each site are aggregated in the BES index, which gives an overview of the BES for each square kilometre of land. For aggregation, a weighted average of the provision of the BES present at each site is generated, wherein all 10 selected BES are assigned the same weights.

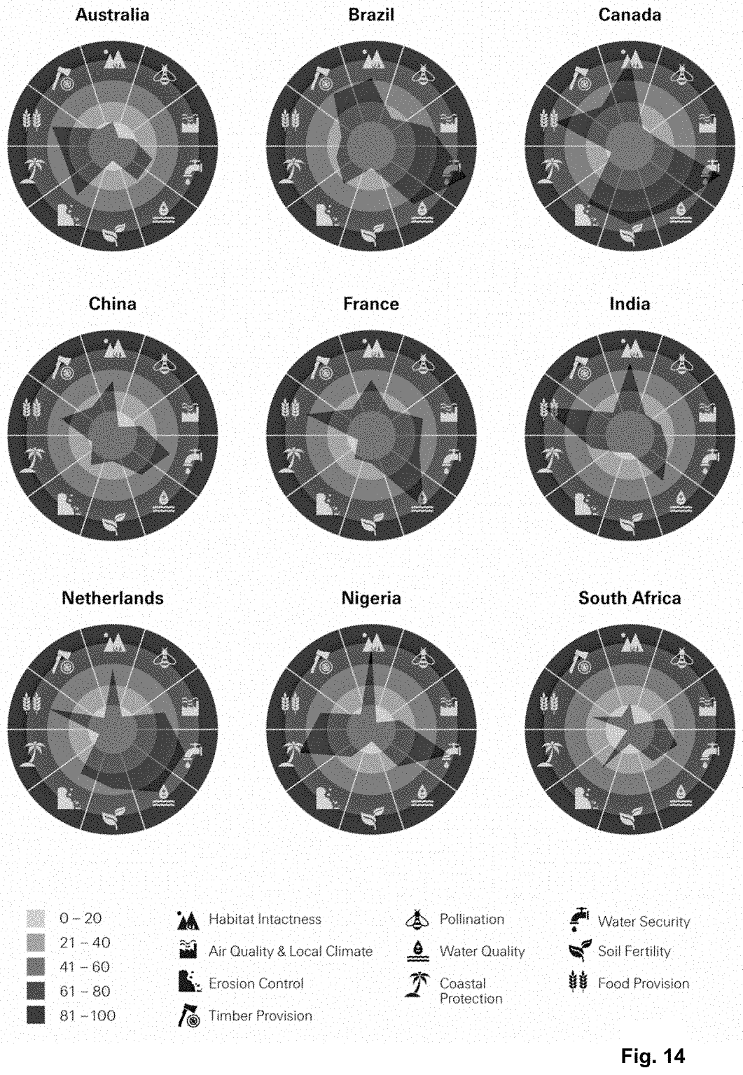

According to the invention, the values of the BES index are classified worldwide in 7 classes according to the 15th percentile classification; the classes range from “very high” to “very low” and in view of the similar values the medium classes are defined as “moderate”. Sites with high values of the BES index (“Very high” BES—upper 15th percentile globally) are assigned to an intact ecosystem with significant value for biodiversity and high capacity for provision of ES (ecosystem services); sites with low values of the BES (“Very low” class—lower 15th percentile globally) are regarded as sensitive ecosystems, which have suffered under the effects of degradation. The system is set up to extend data to threatened species. FIG. 14 shows the changes on the map of the BES index, when very high-capacity and very low-capacity sites are superimposed. If it were necessary to formulate recommendations on environmental and nature-protection policy for the respective sites, it would be urgently necessary to improve the ecosystem conditions of the very low-capacity sites and maintain the very high-capacity sites. This could be achieved either through the restoration/improvement of the ecosystem—an opportunity for many economic sectors—and/or through a systematic and continuous reduction of the negative effects of socio-economic activities. For all other sites the main focus should be promotion of sustainable development.

Most of the results can be made available for example as maps in an automated online information and mapping system for natural hazards. A tool such as HMI (human machine interface) to the BES index makes it possible for example to enlarge individual regions in a zoom function and provide tailor-made maps. Users can import their own coordinates and data into the tool, in order to generate tailor-made data sets, as illustrated e.g. in FIG. 15.

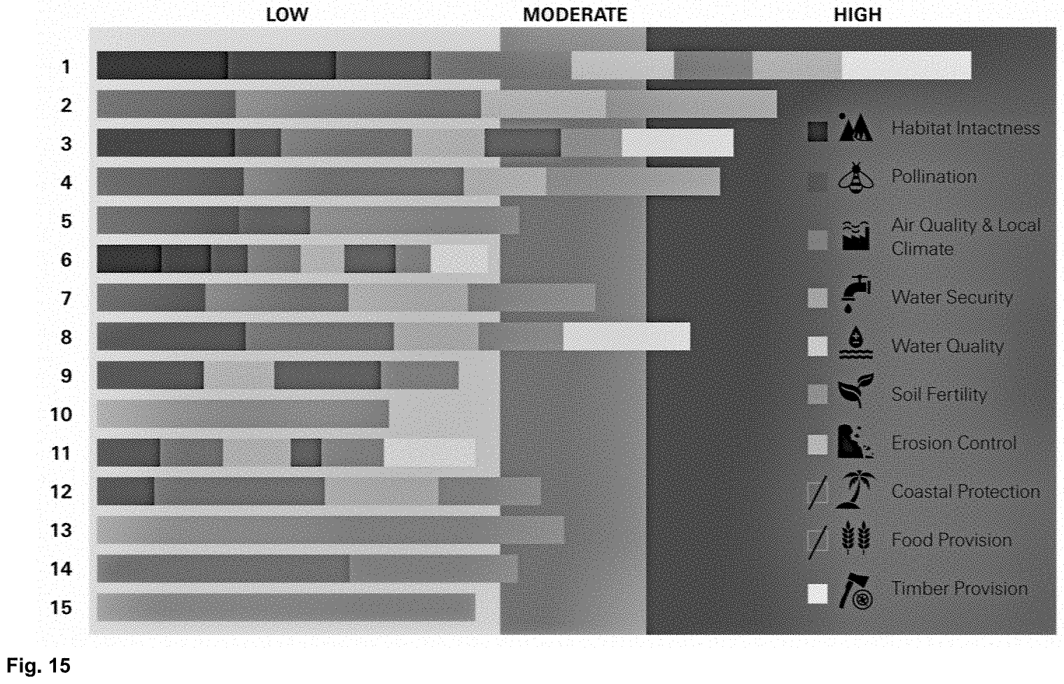

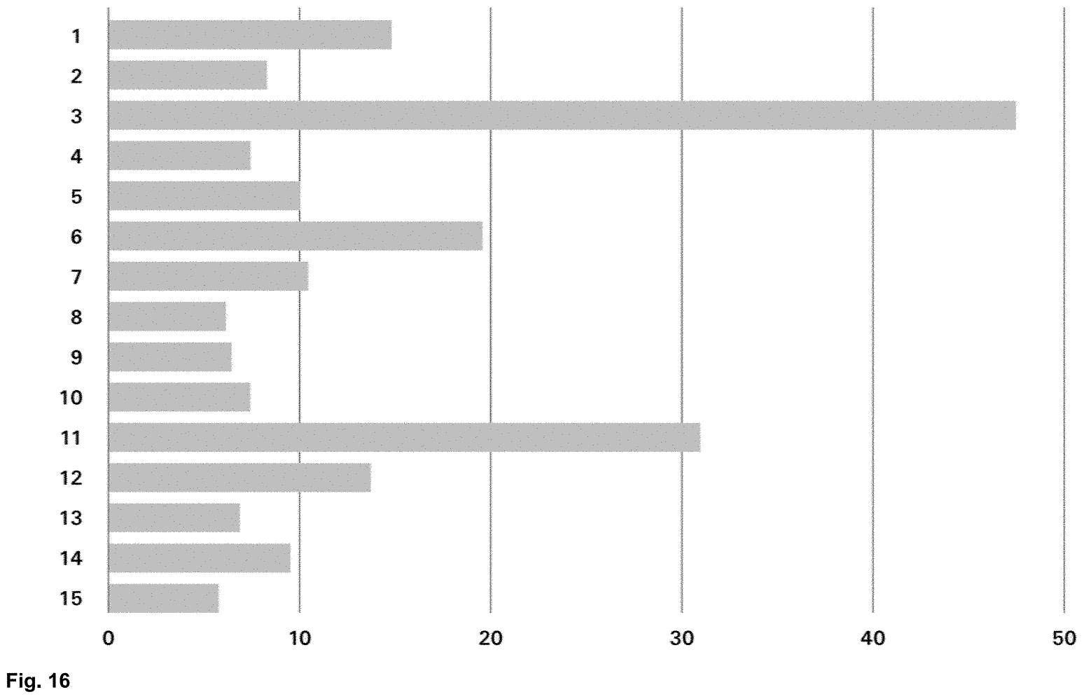

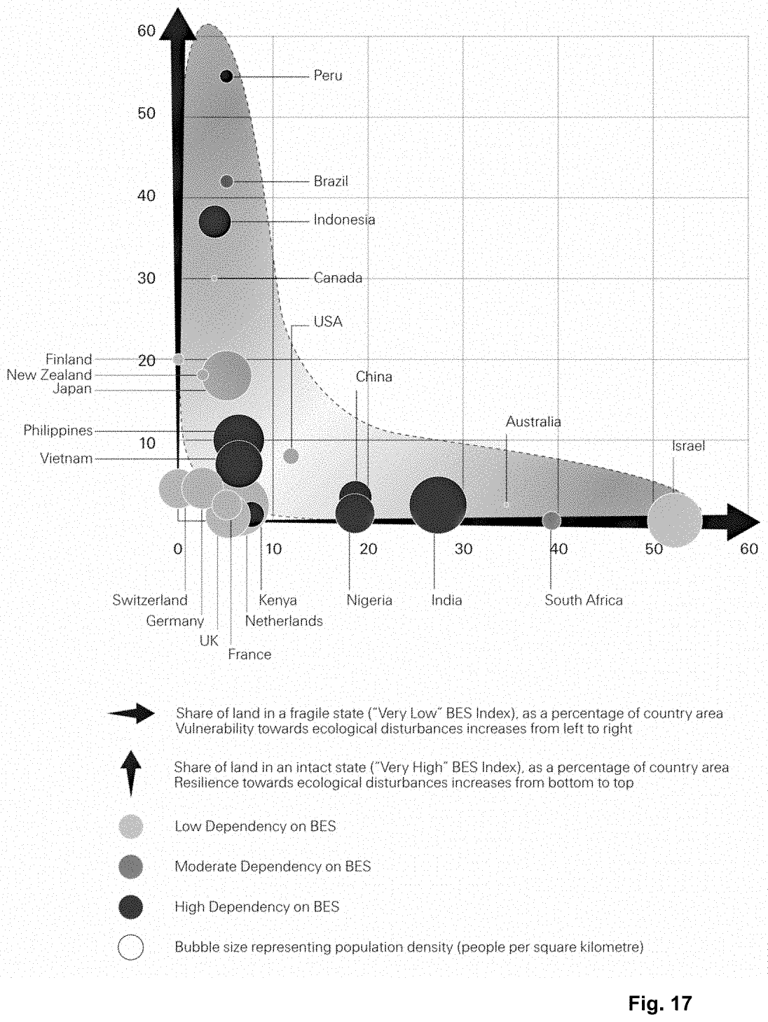

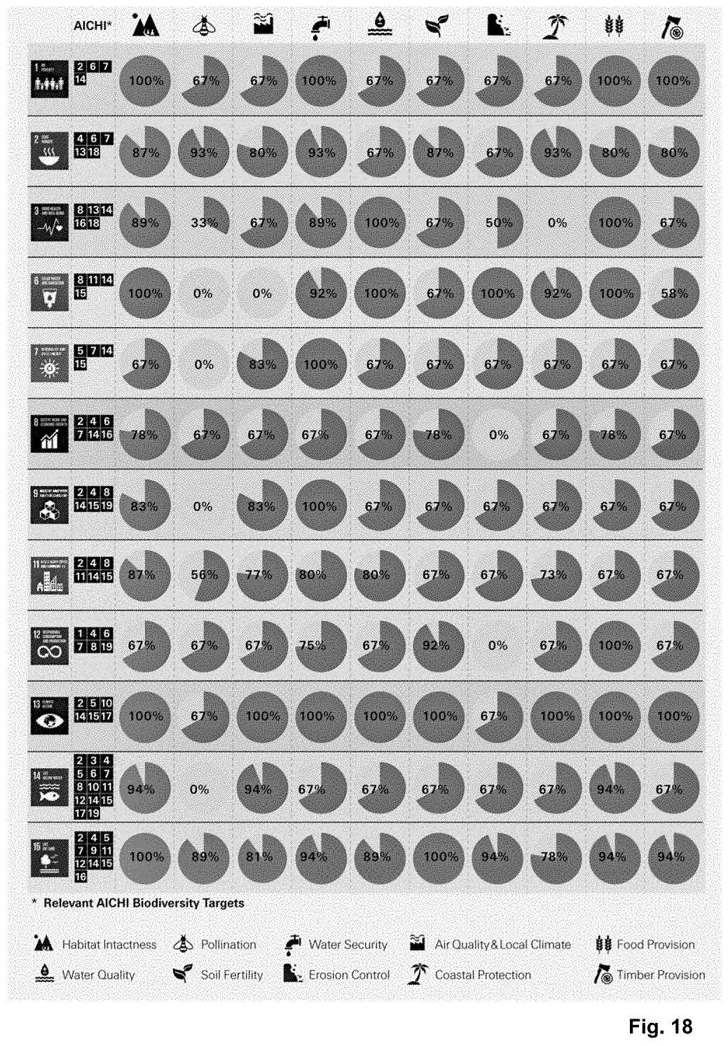

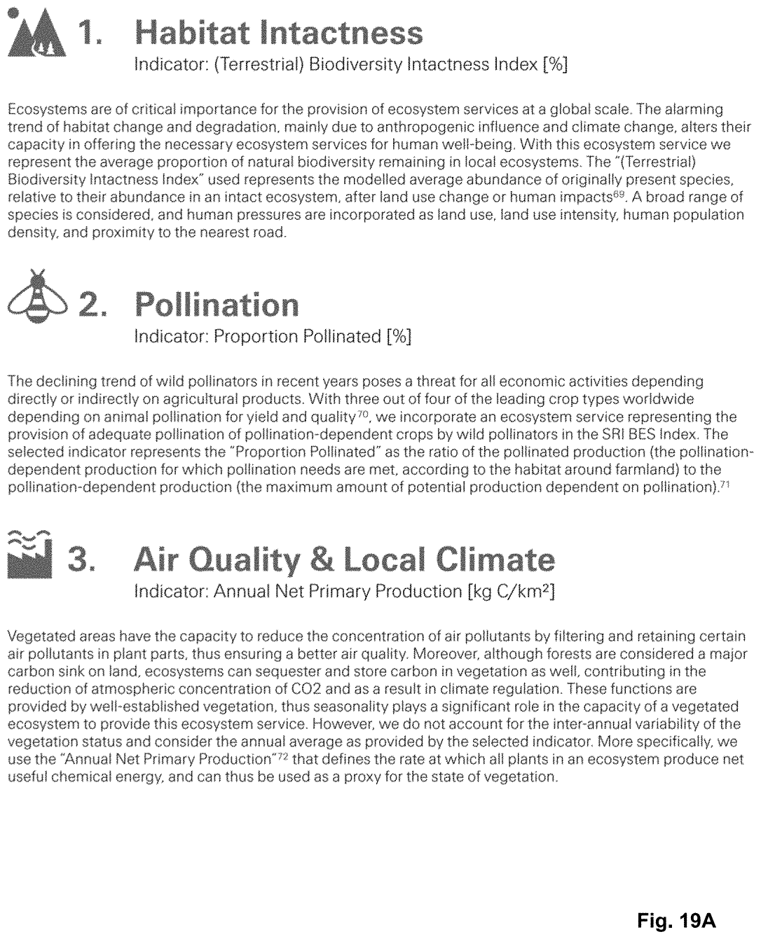

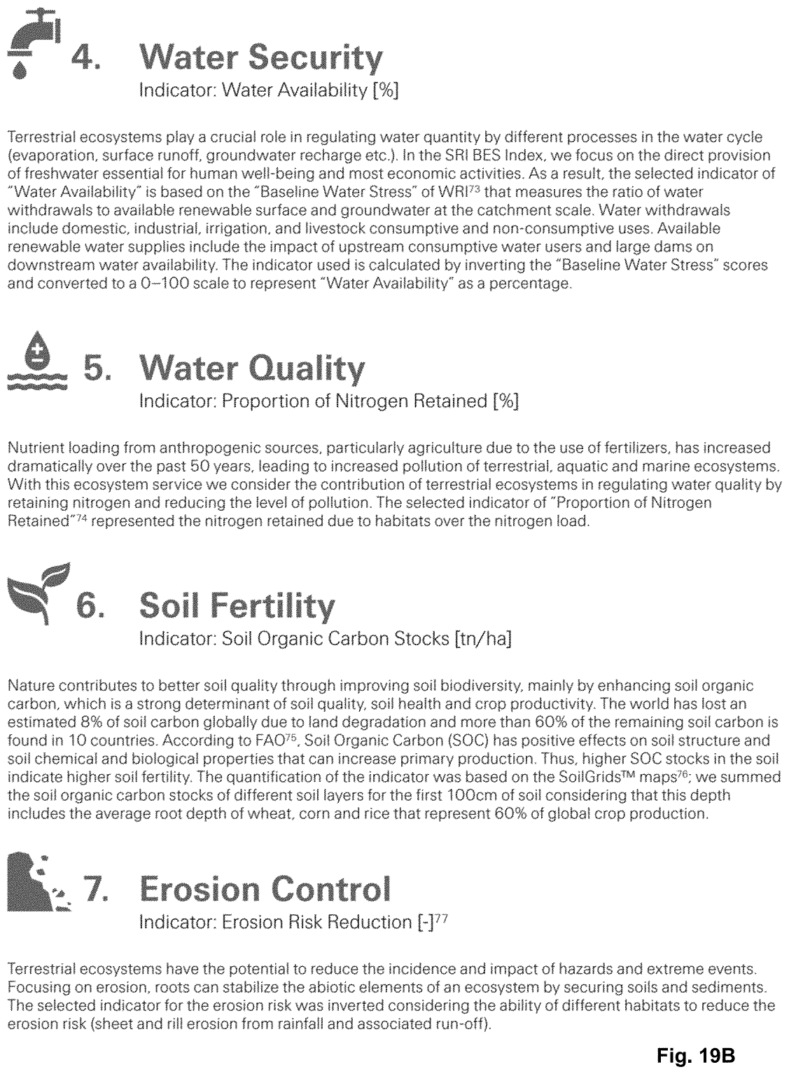

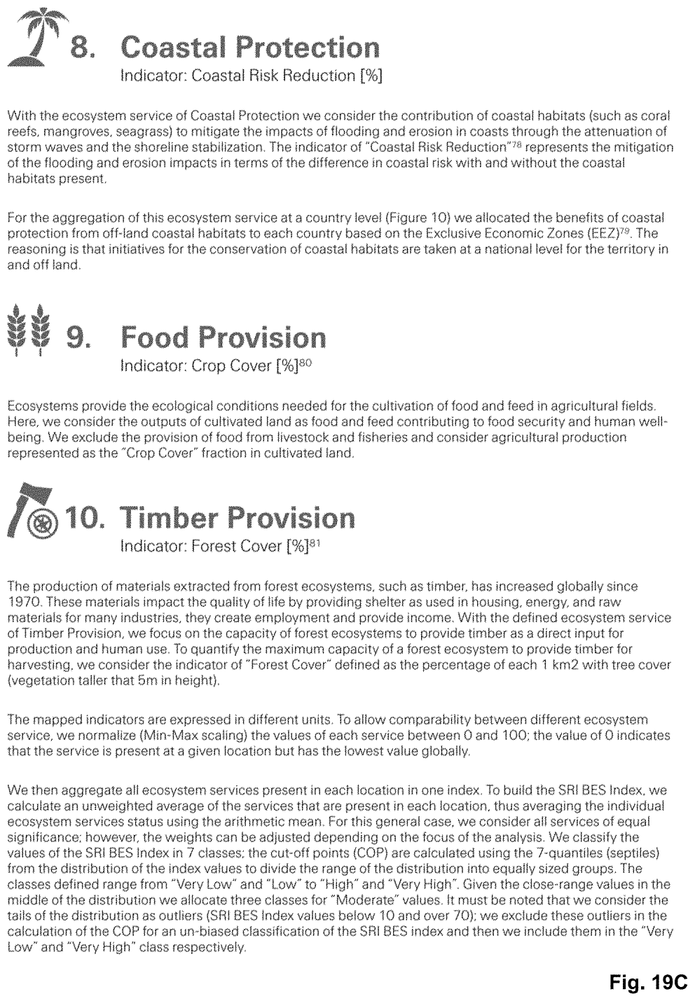

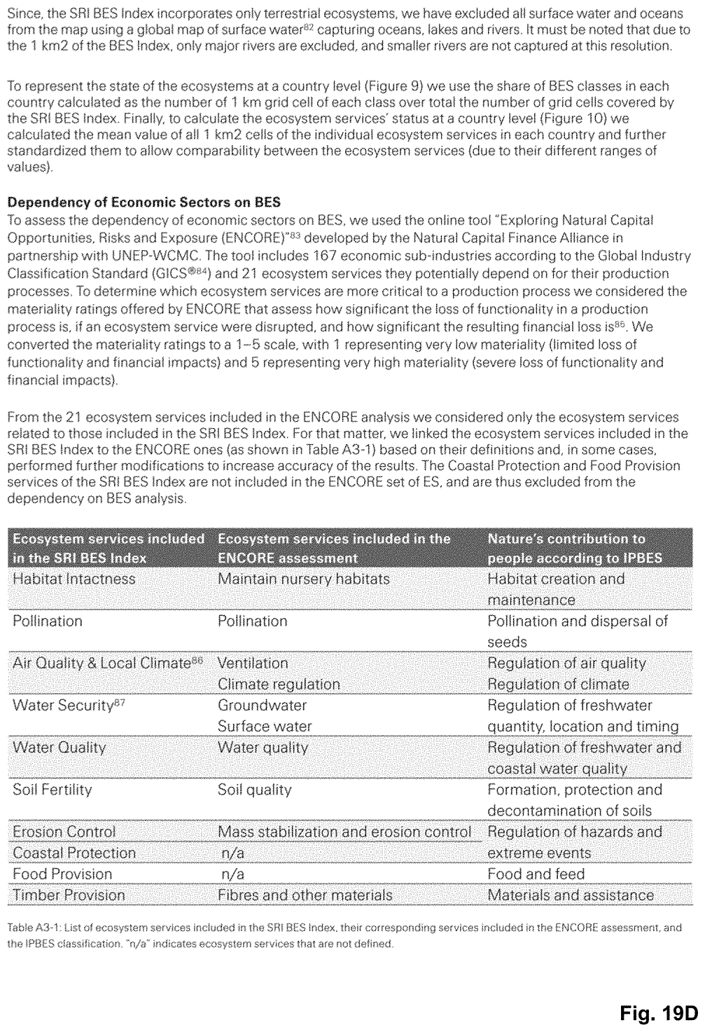

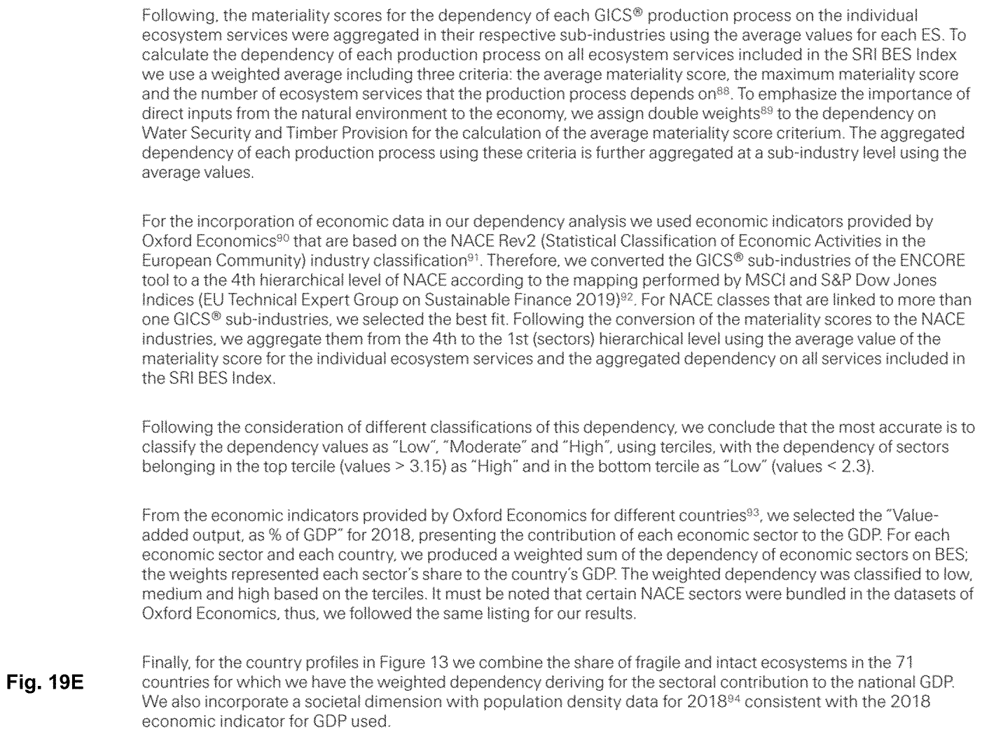

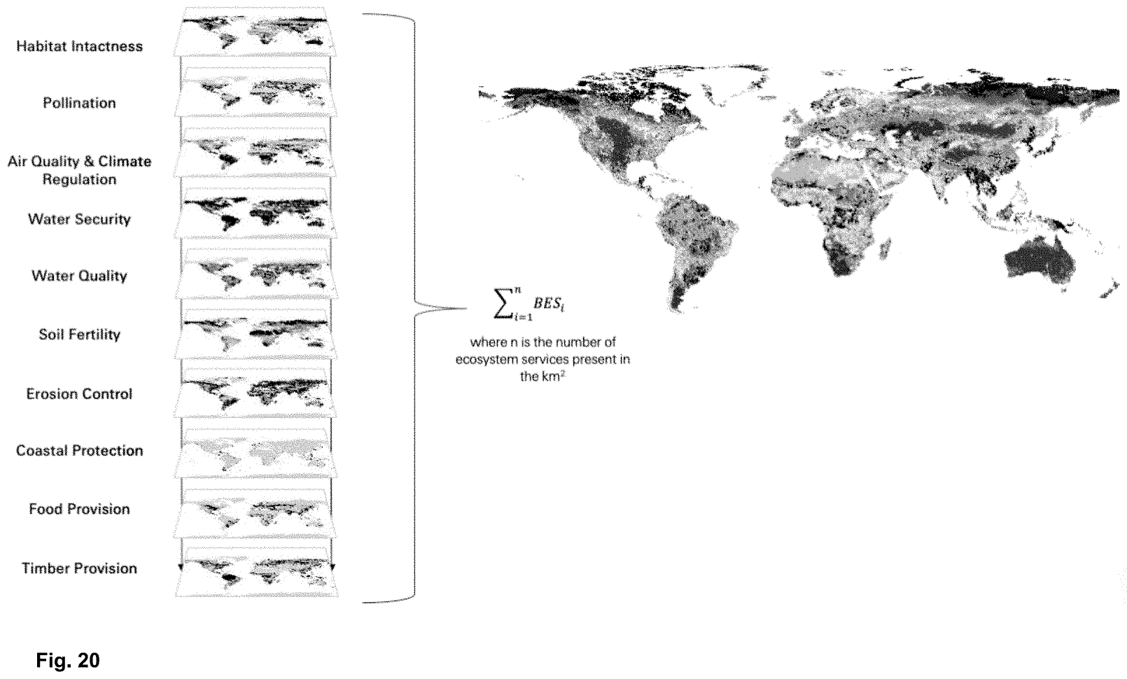

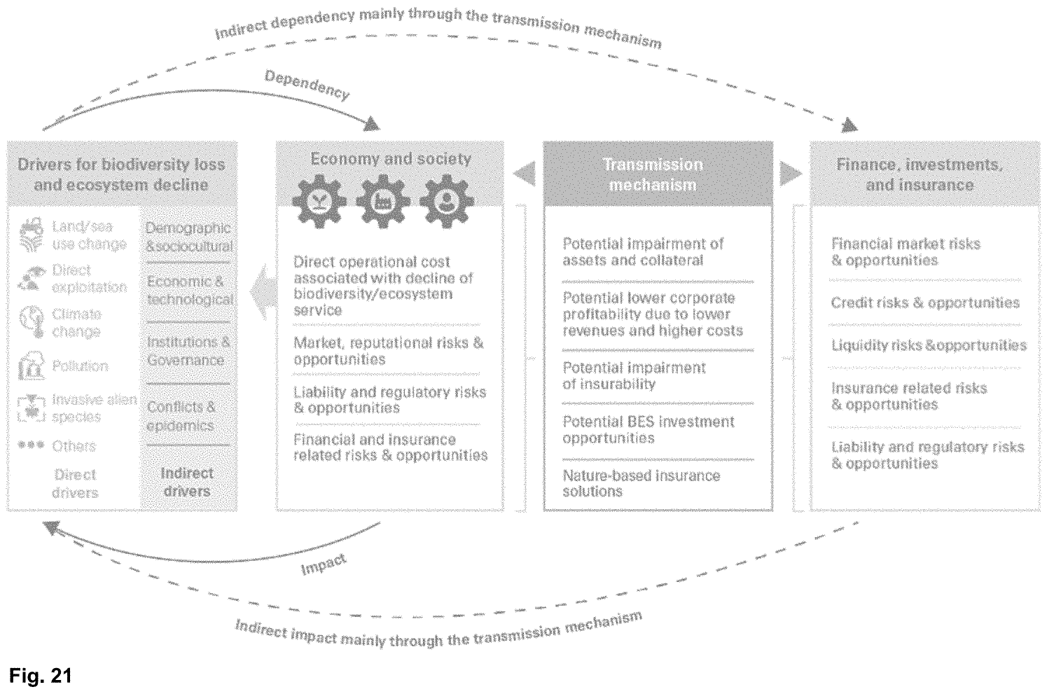

In a further step, the state of the ten ecosystem services is assessed and aggregated at country level. FIG. 16 shows the distribution of the aggregated state of the ten ecosystem services over the seven classes for a selected range of countries for the total land size. This allows cross-comparison of the state of the ecosystem services in different countries. FIGS. 17-19 contain a list of the top 20 countries with the highest share of high-capacity ecosystems (“Very high” BES) and the top 20 countries with the highest proportion of low-capacity ecosystems (“Very low” BES). FIGS. 17-19 show diagrams each with a table showing the proportion of low-capacity (“very low” BES class) and high-capacity (“very high” BES class) ecosystems as area of the respective class relative to the area of the country, which is taken from the BES maps. For the dependency values, the GDP-weighted dependency scales using min-max scaling are included, to make comparability possible. FIG. 17 shows a ranking of countries based on the proportion of low-capacity ecosystems (n.a.=no sectoral GDP breakdown available); FIG. 18 shows a ranking of countries based on the share of high-capacity ecosystems (n.a.=no sectoral GDP breakdown available), and FIG. 19 shows a ranking of countries based on the GDP dependency of biodiversity and ecosystem services (BES). FIG. 20 shows (again for a selection of countries) the state of the individual ecosystem services within such a country. This makes further differentiation and cross-comparison of the individual ecosystem services possible. One of the results of measurement by means of the BES index and the corresponding measuring system according to the invention is that for example 54 countries (or 22% of all countries) have ecosystems on more than 30% of their land that are classified in a low-capacity and thus quasi-fragile state. On the other hand, 34 countries (or 14% of all countries) have ecosystems on more than 30% of their land that are classified in a high-capacity and therefore quasi-intact state.

Industry and the economic sectors correlate directly with the local biodiversity and ecosystem services, or with the measured values of the BES index. Thus, it can be seen in the global picture how the ten ecosystem services contained in the example BES index contribute to the industrial and economic activity, namely: (i) Directly: through physical Input for production processes (water and timber), (ii) Indirectly: through conditions that are essential for production processes (habitat intactness, pollination, soil fertility, water quality, air quality and local climate), and (iii) Protectively (protecting/defensive): protection of production processes against disturbances through extreme events (erosion protection and coastal protection).

Loss of biodiversity represents a threat for all industrial and economic sectors, as they are dependent directly or indirectly for their activity on the provision of ecosystem services. An analysis highlights the technology and economic sectors that are more heavily dependent on Nature, in particular the dependencies that are more material, and the exposure of each country to the risks and implications of BES decline. In order to assess to what extent technology and economic sectors correlate with the BES or to calibrate the BES index, it is additionally possible to use tools such as the online tool “Exploring Natural Capital Opportunities, Risks and Exposure (ENCORE)” developed by the Natural Capital Finance Alliance and the UNEP-WCMC (United Nations Environment Programme World Conservation Monitoring Centre, also World Conservation Monitoring Centre). The materiality assessments are converted and the dependency of the production processes on various ecosystem services is assessed on a scale of 1-5, where 1 stands for a very low materiality (limited loss of functionality and financial effects) and 5 stands for a very high materiality (heavy loss of functionality and financial effects). In order to adjust the BES index with such an analysis, i.e. use for its calibration, for example the measurements of the ecosystem services of ENCORE were linked with the BES system on the basis of their definitions and only the ecosystem services contained in the example BES index were triggered or taken into account. In addition, the dependencies of the individual ecosystem services were aggregated to one value, in order to determine to what extent a respective technology or economic sector (NACE Level 1 (NACE Rev2 industry classification (Statistical Classification of Economic Activities in the European Community))) is dependent on the BES. The correlation or the dependency that belongs in the uppermost tercile (values >3.15) is classified as “high” and that in the lowest tercile as “low” (values <2.3). FIG. 11 shows these results: agriculture, forestry and fishery are dependent on all BES investigated. The health service is strongly dependent on the availability of water for medical operations and on erosion protection for protection of the physical Infrastructure. In general, erosion protection plays an important role for economic sectors that are only dependent on the (building)/infrastructure. It is to be noted that the dependency of the individual sectors is found from the aggregation of the dependency at a NACE Level 4 (approx. 600 classifications of sectoral branches of technology and the economy). This makes an analysis of the dependency at sectoral level possible on the basis of the branches contained in each sector.

By taking into account the global sectoral dependency on biodiversity and ecosystem services BES and taking into account the different value contributions of these sectors, e.g. to the global GDP, the measurement results of the BES index make possible a new view on technology development and world economy, wherein typically a higher correlation or dependency leads to a higher exposure to danger, i.e. higher risks or higher measured rates of effects. This view used here may for example be designated as “endangered value contribution based on the dependency of the economic activity on BES with the highest effects on GDP”. It is found by multiplying the percentage share of a technology or economic sector in the global GDP contribution (according to the sector classification of NACE Rev. 2) with the dependency ranking of the BES of ENCORE for this sector (scale 1-5, FIG. 20). Taking into account the aforementioned threshold values, 29% of the global GDP is strongly correlated with the BES, whereas about 26% of the global GDP is moderately dependent on the BES. This means that 55% of the global GDP is moderately or strongly dependent on the BES. A sector-specific examination implies that i) the processing industry, ii) the real estate business and professional and administrative activities and iii) wholesale and retail trade; repair of motor vehicles and motorcycles, from the economic viewpoint are priority sectors (FIG. 20), in particular for policy relevant questions, where the correlation with the BES must first be reduced, for preventively reducing potential risks for the economy and technological development.

The country-specific view produces a boomerang-like envelope. By means of the BES index, it is possible to assess the correlations of the various national economies with the BES and endangerment of them by risks that arise from the biodiversity loss or ecosystem degradation. For this purpose, for example the measurement indicator “value-added output in % of GDP” of Oxford Economics can be used as a weighting, wherein the weighted total of the dependency of the BES from all sectors of a country is formed. A list of the ten countries most and least dependent on GDP is given in FIG. 17. Finally they can be related to the map of the BES index (FIG. 4 and FIG. 16) for the share of high-capacity and low-capacity ecosystems in each country. They are combined with the analysis of the economic correlation and dependency, wherein the population density is added as an indirect driver for the BES decline (FIG. 23). This country perspective shows a clear separation between countries with a high proportion of very high-capacity ecosystem services and countries with a high proportion of very low-capacity ecosystems. With this technical approach, the concept of a global “BES boomerang” was developed (FIG. 23). FIG. 23 shows a selection of all countries, measured according to their share of land in a low-capacity state (x-axis) and their share of land in a high-capacity state (y-axis). The “boomerang” curve is the envelope over all countries. Based on the understanding according to the invention, countries with a high proportion of land with a low-capacity state of the ecosystem services are susceptible to ecological disturbances. Countries with a high proportion of land with a high-capacity state of the ecosystem services are resistant to ecological disturbances. According to the invention, the term “boomerang” is used here to emphasize the importance of active, functional nature conservation for a functioning technological development, industry and therefore economy. Boomerangs can return, and in this case the means of production (raw materials, water, air and erosion) are endangered if Nature is excessively depleted and overexploited. As measurements with the system according to the invention have shown, countries at the edge of the boomerang should have a stronger focus on (i) conservation of the ecosystem—for those with a high share of high-grade intact BES: to protect what they have for the future generations, and (ii) restoration—for those with a high share of very fragile BES: to (re-)build green, in order to avoid abrupt changes, independently of industrial and economic dependency and population density.

Some examples are given below, for how the results in FIG. 23 can be used for further interpretation of the results:
(i) Countries with a small share both of high-grade higher-capacity (=‘more intact’) and high-grade lower-capacity (=‘more fragile’ BES): Switzerland, for example, has a medium population density and a small dependency of GDP on BES. To improve the resilience of the BES, Switzerland would have to invest more in Nature (e.g. restoration of ecosystems and improvement of the habitat of already protected areas, integration of ecosystem services in development planning, dealing with nitrogen problems etc.). Despite the low dependency of GDP on BES, which can mainly be attributed to the comparatively small share of agriculture in the Swiss GDP, countries like Switzerland are not “safe havens” with respect to ecological or other disturbances. In contrast, Vietnam, as the BES index shows, with a somewhat higher population density than Switzerland, but a much higher dependency of GDP on BES than Switzerland, should manage population pressure further, so that its BES does not become more susceptible and less resistant to BES decline. Vietnam should also continue the diversification of its economy and for example minimize its dependency on food imports.
(ii) Countries with a high share of high-grade intact and a small share of high-grade fragile BES: From the economic viewpoint, these countries may feel “safer” with respect to potential BES shocks if their GDP is not so strongly dependent on the BES (light orange circle) and their population density is low (small circle in FIG. 23). Japan has extensive regions with largely intact habitat, and its economy is based on the secondary and tertiary sector. However, most of the Japanese population is concentrated in large urban areas and is exposed to natural disasters such as earthquakes and tropical cyclones (typhoons), which are not included in BES shocks. If the economy of a country is strongly dependent on BES and at the same time is densely populated, measures for better management of the population density should be accompanied by diversification of the sectoral industry and businesses, in order to become less dependent on natural resources (e.g. in Indonesia).
(iii) Countries with a high share of high-grade ‘fragile’ and a low share of ‘highly intact’ ES (ecosystems): Countries like India or Nigeria with a high population density (large sphere) and a high dependency of GDP on BES should tackle potential BES shocks immediately. Countries like Australia (low dependency of GDP on BES, low population density) should in contrast prepare for ecological disturbances—and look for possibilities for improving and restoring ecosystem services. A long-term political goal could consist of first becoming less susceptible and then “moving” into the area in which e.g. Japan is situated.

Also in potential risk transfer cases, automation of risk transfer can be supported by the BES index 302/3021 . . . 3031, for example:
(i) Recognition and measurement in the case of overlaps of known measurable individual risks with the BES (biodiversity and ecosystem services): Such an overlap can provide first-hand findings if a unit that is exposed to hazards, e.g. as potential or actual insured party, is active in damaged or unaffected ecosystems or if and to what extent an industrial activity at a particular location is dependent on the BES. A site-specific view can also show where the BES is already limited, so that future activities could be susceptible to operating interruptions. In addition, it can demonstrate where property values could be protected by BES against natural hazards.
(ii) Provision of risk-relevant measured data: The various Indices identify hot spots (either where they are fragile/threatened or intact). It is possible to superimpose them with protected areas, if relevant to measurement or evidence.
(iii) Development of nature-based, automated monitoring and risk transfer systems: The values of the measuring parameter for acquisition of the BES may form the basis for nature-based, automated monitoring and risk transfer systems. Examples of this are nature-based clean water in areas with water scarcity, improvement of fisheries through restoration of mangrove forests or return of degraded areas to agricultural areas through restoration of soils. In addition, screening and prioritization of sites where ecosystem services reduce natural hazards.
(iv) To make nature-based, automated, monetary recognition and disclosures possible: Metrological quantification of BES dependencies and BES effects can provide technical support for an impending risk transfer activity.

(d) Further Impacts of the Measuring System According to the Invention and of the Associated Biodiversity and Ecosystem Services (BES) Measurement Index

The United Nations (UN) recognized the importance of biodiversity and declared by 2020 five strategic goals and twenty targets (these are called Aichi biodiversity targets), to stop biodiversity loss. Although many of these goals and targets were not achieved, the international community has begun to negotiate a new biodiversity framework. FIGS. 24a and 24b show the UN's Aichi biodiversity targets up to the year 2020. In the year 2018, four out of ten of the 250 largest industrial enterprises in the world, when questioned in an analysis, used the SDGs (Sustainable Development Goals; the UN's objectives for global assurance of sustainable development at the economic, technological, social and ecological level) in reporting, in order to illustrate their relations and activities for the SDGs. This trend can certainly also be observed for the risk transfer industry. To the extent that the insurance and reinsurance industry is continuing with the development of sustainability strategies and action plans, they are increasingly also investigating how they can go a step further in relation to the SDGs, by incorporating the SDGs in their core business strategy, business decisions and key performance indicators (KPIs).

Many risk transfer activities (automated or not automated) already contribute to attainment of the SDGs, although the activities and their contribution have only rarely (if at all) been described in this way—this also applies to the Aichi targets. The SDGs and the Aichi targets are independent of the industrial sector, and as such the technical targets, in particular measuring technology and monitoring technology, but also the other targets, partial targets and indicators are not risk transfer-specific. Furthermore, the idea of developing further risk transfer structures, to address the SDGs, has been taken into consideration by some, but the demand has not yet been met by the industry. The SDGs try to cover the diversity of sustainability—ecological, social, industrial-technical and economic, many aspects of which contribute to BES or are dependent on these. The Aichi targets try to cover the complexity of biodiversity and ecosystem services. The present invention makes it possible to demonstrate links between 12 SDGs and the ten ecosystem services contained in the BES index. It is already clear from this number how important the BES and the BES index are for reaching the UN targets by 2030. A key technical question is: How does risk transfer technology integrate the attainment of the SDGs in business strategy and structure? This begins with the mapping and prioritization of the (BES-linked) SDGs. First, the risk transfer industry must be aware of how its operations support or do not support a particular SDG: Does it support the attainment of the SDGs? Is it even detrimental? Is there a measurable conflict of aims, e.g. in supporting climate protection measures, but damaging life on land? Therefore a process is required for establishing an action plan and of benchmarks with the 2030 target date. Sensitization is an important step, and the BES index according to the invention, measurement thereof and large-area monitoring, may in this respect be an invaluable technical tool and form the basis for deciding which activities at which locations should be continued, altered or discontinued. In fact, various studies show that it a decisive step towards successful inclusion in policies and planning, to make ecosystem services technically comprehensible and visible (cf. Wood S. et al., 2018. Distilling the role of ecosystem services in the Sustainable Development Goals. Ecosystem Services 29 (2018) 70-82).

BES-linked SDGs, which are currently classified by the insurance and reinsurance industry as priorities: no hunger, health and wellbeing, clean water and sanitation, sustainable towns and communities and climate protection. These are all SDGs that are heavily dependent on BES and are strongly correlated with these. At present, however, the insurance and reinsurance industry in general has no precedence for life on land or life under water.

The problem of SDGs 14 and 15: Preservation of biodiversity and ecosystem services form the basis of SDGs 14 “Life underwater” and 15 “Life on the land”, and their contribution to the ecosystem services and to human wellbeing underpins the attainment of all other goals. As demonstrated in studies, the effectiveness of the currently prescribed SDG framework for the protection of biodiversity is uncertain. For various reasons, social and economic, especially industrial questions are preferred to environmental questions. The two directly interrelated SDGs (life under water, life on the land) often receive the least attention and the least prioritization, for which the BES index according to the invention can serve as a technical aid, especially as better measured data and technically based analyses are the most important reasons identified for this deficit. In view of the fact that the two biosphere targets of life on the land and life under water underpin all other SDGs, it can clearly be established based on the results of the BES index that they should be expressly taken into consideration in prioritization of the SDGs on which the insurance and reinsurance technology will concentrate. The SDGs and the Aichi strategic plan support and strengthen each other, and therefore the realization of one contributes to the attainment of the other. For a better understanding of how BES research could contribute to both objectives, the degree of support of the various SDGs by the ecosystem services contained in the BES index according to the invention can be measured, monitored and assessed. Assessment was based in particular on mapping of the contribution of the BES to the attainment of the targets for 12 SDGs by means of the BES index and the links between SDGs and the Aichi biodiversity targets. The targets of the SDGs can thus be aggregated technically, and the results allow the degree of support of each of the ecosystem services for the 12 SDGs to be measured, wherein the maximum represents a strong support level for all targets assessed in these SDGs (FIG. 25). The results make the incredible importance of the aspects of biodiversity and ecosystem services comprehensible by technical measurement, which were taken into account in the present research and development for the SDGs and Aichi targets. “Urgent climate protection measures” and “Life on the land” merit special mention, with very strong support by the ecosystem services examined. “Clean water and sanitation” with the associated Aichi targets is strongly supported. If the insurance/reinsurance industry were to give priority to one of the 12 SDGs assessed here and work towards its attainment either from the “do no harm” or from the “contribution towards” perspective, this development could serve technically as a useful tool. The world's sustainability challenges require a multilateral response. The insurance and reinsurance industry can not only use this research, in order to contribute to the attainment of their industrial sector and company goals, but also to support their governments in fulfilling the obligations of the countries to meet both the SDGs and the Aichi targets, which are set down in the strategic plan. The world's sustainability challenges require a multilateral response. The insurance and reinsurance technology can not only use this research, in order to contribute to the attainment of their technology and company goals, but also to support their governments in fulfilling the obligations of the countries to meet both the SDGs and the Aichi targets, which are set down in the strategic plan. The technical quantification and quantified measurement of the state of the various BES is open to dispute, because it contains a certain measure of subjectivity, depending on the definition. Certain ecosystem services depend on the expectations of the interest groups or are relative to a subjectively defined state. In addition, more services can be defined than are proposed and acquired by means of the system according to the invention presented here, or the services can be grouped using various classification methods. The spatial resolution used also involves technical uncertainty: Although a global coverage of 1 km² is absolutely ‘high-resolution’ for many services, it may vary beyond this scale for other services. Similarly, the technical quantification of the dependency and correlation of the industrial and economic sectors on the BES, which was used here as an example, is a general, generic quantification, which starts out from similar production patterns and from similar land use practices of certain sectors in various countries. Agriculture is the best example here. Whereas it is generally assumed that many practices of ecological farming have fewer long-term negative effects on the BES, the dependency of ecological farming on BES is higher. This differs from more intensive land use practices, which for example work with artificial fertilizer and pesticides—which leads to a gradually lower dependency on BES, but has a much higher possible negative effect on the BES as well as on climate change. Furthermore, country-specific export-import relations or international input-output tables, which are linked to all BES in the area covered, to develop dependencies of the BES in other countries, are not yet available and therefore were not taken into account in the system according to the invention. However, when available they can be incorporated without prohibitive technical expenditure.

The technical limitations are clear, which are intrinsic to the mapping of the BES used here, and future technical Innovations may support improvements to the automated mapping and monitoring by means of the BES index presented here. In order to see how the state of the ecosystem services develops over time, it is necessary to monitor the structure of the BES index periodically, e.g. at least every three to five years. As a technical precondition, the data used must be measured again periodically. In a careful interpretation of the values of the BES index, it must be taken into account that there is no direct ecological significance of the measurement index, but that it is a technical measurement index. Thus, for example, it is not predicted whether the locations identified as “fragile” (low-capacity) or “very fragile” (very low-capacity) will collapse in the near future. However, this indicates where to be more careful in respect of socio-economic activities—because these locations are endangered. From the country perspective, priorities are set during identification, where further local assessments must be carried out. At this point it should again be pointed out that the BES index represents a technical tool for automated monitoring and signalling of further systems, in particular expert and alarm systems to support decision-making and automated pattern recognition, because for example risk transfer technology is looking right now for said identifications and technical measurement indicators. Recognition of these technical limitations should not, however, hamper reducing the dependency and effects, especially not when the state of the BES is fragile or very fragile. Rather, it should be shown that an actor-whether an industry, an enterprise or a government—can already reduce dependencies measurably, for example by ascertaining the technical structure of its production facilities and/or of the suppliers and observing and automatically monitoring the state of the BES at a particular location.

(e) Summary of the Measuring and Monitoring System According to the Invention and the Corresponding Biodiversity and Ecosystem Services (BES) Measurement Index

In the starting situation for the present invention, some measuring parameters and indicators of the Dutch National Bank (DNB) were observed: 510 billion euro or 36% of all investments of Dutch financial institutions are at risk through the decline of the ecosystem services in the Netherlands.

These two numbers show the current economic situation. The invention provides a technical measurement index, which in particular indicates by measurement where BES dependency is to be found around the world. Using this measuring instrument according to the invention, we can see which BES are available at a particular location, and what their status is. These data can be used for effective decision-making, in particular by means of automated monitoring, alarm and expert systems, regarding the question of how the performance of the BES can be obtained or improved. The invention creates a possibility for monitoring, measurement and detection of (i) the medium to long-term action perspective for the BES at a particular location; (ii) the dependency and correlation of industrial and economic activity on the BES at a particular geographic site. The measurement results can for example support industry in its efforts to reduce its dependency on the BES and monitor it automatically. The same applies for example to the selection of new sites. Both scenarios will benefit the reliability and loading capacity of the corresponding industrial sector. Furthermore, it may prompt industry to take into consideration and apply slimmer and safer methods, if it involves the usage of the various BES.

The finance industry and finance-related technology can also use the BES index similarly for automated monitoring, alerting, automated signalling of third-party systems and corresponding expert systems, in particular based on geographically distributed automated pattern recognition. The price of financing or risk transfer should take into account the measured level of fragility or intactness of the BES. Heavily BES-dependent activities in fragile areas possibly do not have a sustainable future, and the use of the BES index may thus support corresponding expert systems in distributing the resources correspondingly. The price that the finance industry demands for the provision of capital—whether via investments or risk transfers—must reflect the predicted, measured risk associated with the BES. The technical tool and technical means presented here make it possible to make these decisions and monitor them automatically in future, to make technical installations and industry reliable and resistant to a possible external shock of exhaustion of the BES.

For public facilities and economic decisions, the BES index and the measuring and monitoring technology according to the invention can provide technical support e.g. in the prioritization of conservation objectives or the change of zone and development planning, by integrating and measuring the state of the ecosystem services in defined areas. For example, the measurement index enables public facilities to detect potential ecological shortages in densely populated urban or suburban areas and identify and classify them automatically, e.g. by means of pattern recognition based on the measured parameters and indices. Furthermore, the BES index can indicate the need for resource efficiency, in the case of development of new parts of towns within particular settlement areas or the planning of new towns. The BES index can provide technical support for the implementation of nature conservation or environmental policies, wherein the main focus is on the relevant AICHI or UN Post-2020 framework goals for biodiversity or for ecosystem functions. The BES and the BES index can form the basis for nature-based risk transfer solutions and assessment thereof, which should be promoted together with the public sector and interest groups. Examples of this are nature-based clean water in water-stressed areas, the restocking of fisheries through the restoration of mangrove forests, the return of degraded areas to agricultural use areas through the restoration of soils or the verification and prioritization of sites where ecosystem services reduce natural hazards.

The stages of dependency, i.e. correlations, of the BES with the aid of the BES index can warn or generally inform a business leader or a public facility about the current state of the ecosystem services. Looking into the future, they can also measure whether development is going in the right direction. That means that if the financial industry takes the BES criteria as described as the basis for its decision-making as technical measuring unit, the potential negative technical or economic effects on investments, as presented by the DNB, ought to decrease over time. That should be the goal, in order to realize a main objective of risk transfer, in particular to promote corporate resilience. This is proposed here as specific technology, in that the opportunities for automated risk transfer are identified, in order to strengthen the capacity of industry, economy and companies to regain their equilibrium after large setbacks and stimulate growth again. The latter is among other things one of the aims of the present invention, namely (i) by providing technical means and measuring techniques for risk transfer structures, which help, in disasters, to overcome damage and resume or maintain operation; and (ii) by providing the new opportunities for a technology-based analysis and monitoring, to avoid disasters that put humans and industry in danger. The BES index presented here and the corresponding measuring system and method according to the invention relates to the making of reference measurement parameters technically tangible and allows new and innovative risk expertise to be generated. In particular it allows new technical solutions to be developed, which support biodiversity and ecosystem services—and promote sustainable growth. FIG. 26 once again presents a review of some methodological details for the BES index. The table illustrates the ecosystem services contained in the BES index. The presentation is based on the IPBES classification, wherein the ecosystem services contained and measured in the BES index are selected according to two criteria: 1) the relevance of the BES for insurance and reinsurance technology and various branches (LoB Lines of Business) and 2) the global availability of measured data in high resolution. Some ecosystem services were excluded, because they did not meet these technical criteria; the ecosystem services for “Ocean acidification” and “Medical, biochemical and genetic resources” are not taken into account owing to the lack of available global measured data sets at a resolution that is consistent with other ecosystem services, while “Energy” was excluded owing to its limited applications. Finally, the non-material ecosystem services listed in the IPBES classification are not taken into account. As shown in FIGS. 26a-e, the BES index comprises a broad spectrum of measurement contributions to ecosystem services. FIGS. 26a-e describe a selected group of ecosystem services, which can be contained as an example in the BES index, together with the selected indicators for quantification at the global level and other assumptions that are taken into consideration.

### LIST OF REFERENCE NUMERALS

1 Measuring and monitoring system
   11 Measuring sensors and measuring devices
      111 Earth Observation (EO) sensors/satellites
         1111 Atmospheric measurements
         1112 Maritime measurements
         1113 Land-based measurements
         1114 Orbit of the Earth Observation (EO) satellite
      112 In-situ and remote sensing sensors
         1121 Atmospheric measurements
         1122 Maritime measurements
         1123 Land-based measurements
      113 Measured data
         1131 Atmospheric measuring parameters
         1132 Maritime measuring parameters
         1133 Land-based measuring parameters
      114 Technical sensor and measuring device parameters
         1141 Weight
         11411 Large
         11412 Small
         11413 Micro
         11414 Nano
         1142 Power
         1143 Spatial resolution
         1144 Swath
      115 Spatial measurement scale range
2 Storage unit
   20 Production processes and production outputs 1 . . . p
      221 Atmospheric dependency
      222 Maritime dependency
      223 Country-based dependency
      224 Climate change-based dependency
      225 Hazard planning and disaster-related dependency
      216 Safety-related dependency
   21 Correlation measuring indices 1 . . . k for a production process or
      Production output i for each of the BES indicators (materiality index)
      211 Correlation factor relating to habitat intactness
      212 Correlation factor relating to pollination
      213 Correlation factor relating to air quality
      214 Correlation factor relating to local climate
      215 Correlation factor relating to water security
      216 Correlation factor relating to water quality
      217 Correlation factor relating to soil fertility
      218 Correlation factor relating to erosion control
      219 Correlation factor relating to coastal protection
      220 Correlation factor relating to food provision
      221 Correlation factor relating to timber provision
3 Digital platform with central simulation and prediction system
   30 Core Engine
      301 Aggregation module
         3011 Parameterized BES indicators
         30111 Habitat intactness
         30112 Pollination
         30113 Air quality
         30114 Local climate
         30115 Water security
         30116 Water quality
         30117 Soil fertility
         30118 Erosion control
         30119 Coastal protection
         30120 Food provision
         30121 Timber provision
      302 BES indices
         3021 BES index for habitat intactness
         3022 BES index for pollination
         3023 BES index for air quality
         3024 BES index for local climate
         3025 BES index for water security
         3026 BES index for water quality
         3027 BES index for soil fertility
         3028 BES index for erosion control
         3029 BES index for coastal protection
         3030 BES index for food provision
         3031 BES index for timber provision
      303 Cumulative BES index
      304 Correlation module
   31 First risk-transfer system (primary insurance system)
      311 First electronically automated resource-pooling system
         3111 First risk transfer parameters
      312 First payment transfer modules
         3121 First payment parameters
   32 Second risk-transfer system (reinsurance system)
      321 First electronically automated resource-pooling system
         3211 Second risk transfer parameters
      322 Second payment transfer modules
         3221 Second payment parameters
   33 Persistent storage
   34 Data transmission interface
4 Data transfer network
5 Monitored/measured geographic region
   51 Monitored/measured geographic grid
   52 Monitored/measured geographic cell/grid cell
6 Ecosystem
   61 Ecosystem services (BES)
      611 Habitat intactness
      612 Pollination
      613 Air quality
      614 Local climate
      615 Water security
      616 Water quality
      617 Soil fertility
      618 Erosion control
      619 Coastal protection
      620 Food provision
      621 Timber provision

1. A measuring and monitoring system, comprising:
a plurality of measuring sensors and measuring devices configured to acquire geographically cellularly delimited measuring parameters, the measuring sensors and measuring devices including in-situ measuring devices and/or EO (Earth Observation) measuring devices configured to measure values of atmospheric measuring parameters and/or values of maritime measuring parameters and/or values of land-based measuring parameters; and
a central digital platform with a Core Engine and a persistent memory configured to:
implement an aggregation module based on predefined parameterizations of BES (biodiversity and ecosystem services) indicators, the aggregation module storing measuring parameters acquired by the measuring sensors and measuring devices for measuring the BES indicators in the persistent memory and the measuring parameters being aggregated by parameterization of the BES indicators to quantitative values of a BES index for each of the BES indicators and/or a total value of a cumulative BES index,
implement a correlation module including a plurality of parameterized stored production processes and production outputs with assigned correlation measuring indices, the correlation measuring indices measuring a dependency of a production process or a production output on the individual BES indices, respectively, and defined subsectors using average values for each of the BES indicators,
determine and/or measure probability of occurrence values for an occurrence of damage events or reduction of production outputs on the basis of the BES index values, measured BES index values being weighted in relation to the production processes and production outputs using an average value of the correlation measuring indices for the individual parameterized BES indicators and an aggregated dependency of all of the BES indicators contained in the cumulative BES index, and
determine and/or measure the probability of occurrence values for the occurrence of damage events or reduction of production outputs based on the measured and weighted, with respect to the production processes and production outputs using the correlation measuring indices, BES index values using the average value of the correlation measuring indices for the individual parameterized BES indicators and the aggregated dependency of all of the BES indicators contained in the cumulative BES index.

2. The measuring and monitoring system according to claim 1, wherein the BES indicators include at least measuring parameters for measuring at least one of:
habitat intactness,
pollination,
air quality and local climate,
water security,
water quality,
soil fertility,
erosion control,
coastal protection,
food provision, and
timber provision.

3. The measuring and monitoring system according to claim 2, wherein
indicator substances are measured as quantitative indicators for the air quality by the in-situ measuring devices, and
the indicator substances include at least one of:
content of nitrogen dioxide,
fine dust and soot content,
grit content,
a proportion of non-transparent/opaque particles,
dust ingredients comprising pollen, and
sea salts.

4. The measuring and monitoring system according to claim 2, wherein a quantitative measurement of the water quality is measured by the in-situ measuring devices by measuring at least one value of:
electrical conductivity, and
dissolved substances including hormones and/or fungicides and/or pesticides.

5. The measuring and monitoring system according to claim 1, wherein, for measurement, the BES indicators are selected and/or the selection thereof is varied until a defined measurement accuracy of one or more of the BES index values is attained.

6. The measuring and monitoring system according to claim 1, wherein
the correlation module is configured to measure the correlation measuring index of each production process or production output, and
by means of the cumulative BES index, all correlated BES indicators are acquired as a weighted average based upon at least: (i) a measured, average correlation measuring index, (ii) a measured maximum correlation measuring index, and (iii) a measured number of the correlated BES indicators, on which a respective production process or production output depends.

7. The measuring and monitoring system according to claim 2, wherein a correlation measuring index for the water security and the timber provision are assigned a double weighting for generating the cumulative BES index.

8. The measuring and monitoring system according to claim 1, wherein the BES indicators contained in the BES indices are linked based on their measurement relevance to ENCORE (Exploring Natural Capital Opportunities, Risks and Exposure) services, are modified to their maximum measurability, and are weighted with respect to their correlation.

9. The measuring and monitoring system according to claim 8, wherein the subsectors are based on a Global Industry Classification Standard (GICS) of ENCORE.

10. The measuring and monitoring system according claim 1, wherein the subsectors include two or more hierarchic levels based on the NACE Rev2 (Statistical Classification of Economic Activities in the European Community) industry classification.

11. The measuring and monitoring system according to claim 10, wherein
for dependencies based on the classifications, discrete dependency values with values “slight”, “moderate,” and “high” are classified and discretized using terciles, and
a dependency on sectors that lie in the upper tercile is assigned as “high” and a dependency on sectors that lie in the lower tercile is assigned as “low”.

12. The measuring and monitoring system according to claim 11, wherein, for generating the dependency, further measuring parameters for measuring economic indicators are selected.

13. The measuring and monitoring system according to claim 12, wherein
the economic indicators are selectable at least partially from the economic indicators of Oxford Economics for various countries, and
when the “value-added output in % of GDP” is selected, a contribution of each economic sector to the GDP is acquired by measurement and for each economic sector and each country, a weighted total of a dependency of the economic sectors on the BES index is generated and the weights comprise the measured share of each sector in the GDP of the country.

14. The measuring and monitoring system according to claim 11, wherein the weighted dependency based on the terciles is classifiable in low, medium, and high.

15. The measuring and monitoring system according to claim 2, wherein parameter data of the BES indicators of the food provision individually or with aggregation together are be aggregated on a BES index of the timber provision at all spatial levels for each of the BES indicators and are benchmarkable compared to others.

16. The measuring and monitoring system according to claim 15, wherein the spatial levels include at least one of:
towns,
countries,
cantons,
federal states,
nations,
supranational entities, and
spatial levels as NUTS-Il.

17. The measuring and monitoring system according to claim 16, wherein the supranational entities include the European Union (EU).

18. The measuring and monitoring system according to claim 1, wherein the measurements for repeated measurement of the BES indicators and of the aggregation of the BES indicator include time series and/or regular monitoring.

19. The measuring and monitoring system according to claim 1, wherein the central digital platform is configured to implement a multi-location analyses at a level of concrete GIS coordinates as unique address or km² or zip codes and/or postcodes for identifying vulnerabilities in a value-added chain of enterprises against BES loss based on available company data.

20. The measuring and monitoring system according to claim 19, wherein locations of the multi-location analyses include 1st tier and/or 2nd tier and/or 3rd tier suppliers.

21. The measuring and monitoring system according to claim 19, wherein the multi-location analyses is carried out in conjunction with a dependency of an entrepreneurial activity and/or of a supplier based on the NACE classification, which is unambiguous for all entrepreneurial activity and the underlying dependency of the NACE classified activity on the BES indicators.

22. The measuring and monitoring system according to claim 19, wherein the multi-location analyses includes aggregating data at an overall level of an enterprise and benchmarking compared to others.

23. The measuring and monitoring system according to claim 22, wherein the overall level of the enterprise comprises all production facilities including those of suppliers.

24. A measuring and monitoring method, comprising:
acquiring, via a plurality of measuring sensors and measuring devices, geographically cellularly delimited measuring parameters, the measuring sensors and measuring devices including in-situ measuring devices and/or EO (Earth Observation) measuring devices configured to measure values of atmospheric measuring parameters and/or values of maritime measuring parameters and/or values of land-based measuring parameters;
implementing an aggregation module based on predefined parameterizations of BES (biodiversity and ecosystem services) indicators, the aggregation module storing measuring parameters acquired by the measuring sensors and measuring devices for measuring the BES indicators in a persistent memory and the measuring parameters being aggregated by parameterization of the BES indicators to quantitative values of a BES index for each of the BES indicators and/or a total value of a cumulative BES index,
implementing a correlation module including a plurality of parameterized stored production processes and production outputs with assigned correlation measuring indices, the correlation measuring indices measuring a dependency of a production process or a production output on the individual BES indices, respectively, and defined subsectors using average values for each of the BES indicators,
measuring probability of occurrence values for an occurrence of damage events or reduction of production outputs based on measured BES index values relating to production processes and production outputs weighted using an average value of the correlation measuring indices for the individual parameterized BES indicators and an aggregated dependency of all of the BES indicators contained in the cumulative BES index.
